(19) United States
(12) Patent Application Publication
(10) Pub. No.: US 2003/0215549 A1
(43) Pub. Date: Nov. 20, 2003

(54) Candy sucker

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US); William L. Klima, Fredericksburg, VA (US)

Correspondence Address: WILLIAM L. KLIMA, 2046-C JEFFERSON DAVIS HIGHWAY, STAFFORD, VA, 22554, US

(21) Appl. No.: 10/364,314

(22) Filed: Feb. 11, 2003

Related U.S. Application Data
(63) Continuation-in-part of application No. 10/071,225, filed on Feb. 11, 2002.

(51) Int. Cl. A23B 4/00

(52) U.S. Cl. 426/115

(57) ABSTRACT

The present invention is directed to a candy sucker article. Specifically, the candy sucker article includes a candy sucker in combination with a closeable or resealable container.

### RELATED APPLICATIONS

This is a continuation-in-part of U.S. patent application Ser. No. 10/071,225 filed Feb. 11, 2002, currently pending.

### FIELD OF THE INVENTION

The present invention is directed to a candy sucker, in particular to a candy sucker article.

### BACKGROUND OF THE INVENTION

There exists a product known as “Fun Dips” that includes a bonded two layer paper wrapper containing a hard candy in one compartment and powder candy in another compartment. A person using the product tears open one end of the paper wrapper to allow the hard candy to be removed from the one compartment and to open the other compartment containing the candy powder. The person licks one end of the hard candy, and then dips that end into the compartment containing the candy powder to apply same to that end of the hard candy. The person removes the hard candy and licks the end having the candy powder adhered by moisture thereto. The person again dips the wet end of the hard candy into the compartment containing candy powder to reapply the powder candy thereto. This process is repeated until the powder candy is substantially consumed, and then the hard candy is eaten.

The concept of combining a candy sucker with a resealable container storing an edible powder is disclosed in U.S. Pat. No. 5,370,884 to Thomas J. Coleman, which U.S. patent is incorporated herein by reference.

### SUMMARY OF THE INVENTION

A first object of the present invention is to provide an improved candy sucker article.

A second object of the present invention is to provide an improved candy sucker article including a candy sucker in combination with a container.

A third object of the present invention is to provide a candy sucker article including a sucker in combination with a container with a container containing an edible food product.

A fourth object of the present invention is to provide a candy sucker article, including a candy sucker in combination with a container configured for storing an edible food product, the container including a compartment configured to be selectively accessible when the container is open.

A fifth object of the present invention is to provide a candy sucker article configured to simulate a known object or article in appearance.

A sixth object of the present invention is to provide a candy sucker article including a candy sucker in combination with a container, the candy sucker and/or the container configured to simulate a known object or article in appearance.

A seventh object of the present invention is to provide a candy sucker article including a container in combination with a candy sucker configured to be manually rotatable relative to the container.

An eighth object of the present invention is to provide a candy sucker article including a container configured for containing edible food product in combination with a candy sucker enclosed within the container and configured to be rotatable within the container.

A ninth object of the present invention is to provide a candy sucker article configured to simulate an ice cream product.

The present invention is directed to an improved candy sucker article. Specifically, the candy sucker article according to the present invention includes the combination of a candy sucker and container. The container is preferably configured to contain an edible food product.

The present invention is directed to the concept of a candy sucker in combination with a container having a compartment accessible when the container is open. For example, a closure of the container covers the compartment of the container, and when the closure is opened the compartment is then accessible to the candy sucker.

Another concept of the present invention is to provide a candy sucker in combination with a container having a compartment selectively accessible when the container is open.

The article according to the present invention can be filled with contents or unfilled. Preferably, the container is filled with one or more edible food products.

The container can be filled with candy, candy powder, candy granules, candy particles, cookie, cookie crumbs, cookie powder, cookie particles, food powder, flavored powder, flavored granules, chocolate powder, vanilla powder, strawberry powder and other food matter. In some embodiments, it is desirable that the candy sucker is a different flavor and/or consistency with respect to the food contained within the container to provide a variety of flavors when using.

The candy sucker used in the article according to the present invention can take on various forms. Specifically, the candy sucker, for example, can be a hard candy sucker like a lollipop, or can be candy that is suitable to be dipped into another food product and then be licked. Preferably, the candy sucker is formulated to be more slowly dissolving versus the food product into which it is being dipped so that the user can repeatedly use the candy sucker for dipping out the food product from the container.

The candy sucker can be connected to other components of the article such as the container and/or closure, or can be a separate item associated with the article. Specifically, the candy sucker can be packaged (e.g. in a container, shrink wrapped, wrapped) together with the container having a closure. The candy sucker can be packaged within the container and/or closure.

The present invention is directed to a candy sucker including the combination of a container and a candy sucker configured to rotate relative to the container. In a preferred embodiment, the candy sucker is disposed within the container and the candy sucker is configured to rotate within the container. In a more preferred embodiment, the candy sucker both rotates within the container and is configured to extend from the container or be removed from the container to provide better access to a person either licking the candy sucker or placing the candy sucker in the person's mouth. The candy sucker can be configured to be directly manipulated to rotate (e.g. by using a person's finger tips), or can be configured to be indirectly rotated (e.g. by using a manual drive mechanism).

In another preferred embodiment, the candy sucker is stored outside the container, however, the candy sucker article includes a rotating device connected to the candy sucker and configured to rotate the candy sucker once the container is opened to allow a user to place the candy sucker within the container and rotate same to apply an edible food product to the candy sucker. The rotating device is manually operated (e.g. can be manipulate by fingers and/or hands), can be configured to store energy (e.g. spring loaded device, wind up device, top, gyro) to cause rotation, preferably selectively actuated.

For example, a rotating device connected to the container is releasably connected to the container to allow the candy sucker to be inserted into a container once opened to allow the candy sucker to be rotated or spun within the container for applying an edible food product stored within the container onto the outer surface of the candy sucker. Preferably, the person first licks the outer surface of the candy sucker to apply moisture, and then dips the candy sucker within the container and then rotates same with the rotating device.

The present invention is also directed to a candy sucker article having the combination of a container configured for containing an edible food product, a candy sucker, and a light emitting device. The light emitting device can be, for example, a non-battery device energy source such as a small wind up electrical generator or can be generated by phospho-luminescence (e.g. two part solution breakable light stick incorporated within article).

A further embodiment of the candy sucker article according to the present invention is defined by the combination of a container configured to store an edible food product, a candy sucker, and a noise generating device. The noise generating device, for example, can be a mechanically generated noise maker (e.g. whistle, rattle, wind up mechanical siren, wind up noise generator).

An even further embodiment of the candy sucker article according to the present invention is defined by the combination of a container configured to store an edible food product, a candy sucker wherein the article is configured to simulate an ice cream product. For example, the ice cream product can be ice cream sundae, ice cream cone, ice cream scoop, ice cream bar or other ice cream product (e.g. milkshake, Klondike Bar, popsicle, ice cream sandwich, SnoCone, push pop, Godiva ice cream bar, or other ice cream product or related dessert type product). The ice cream product can be simulated by just the container itself, just the candy sucker itself, or both the container and the candy sucker together.

There exists numerous embodiments of other combinations of the embodiments described in detail above. For example, a candy sucker article according to the present invention can include the combination of a container configured for storing an edible food product, a candy sucker, a manually rotating device for rotating the candy sucker, a light emitting device and/or noise generating device. Further, the combination can be configured to simulate an ice cream product. In any event, the present invention is directed to numerous embodiments of these and other features and elements described herein.

### BRIEF DESCRIPTION OF THE DRAWINGS

FIG. 1 is a front elevational view of an embodiment of the candy sucker according to the present invention.

FIG. 2 is a front elevational view of another embodiment of the candy sucker according to the present invention.

FIG. 3 is a front elevational view of a further embodiment of the candy sucker according to the present invention.

FIG. 4 is a front elevational view of an even further embodiment of the candy sucker according to the present invention.

FIG. 5 is a front elevational view showing two (2) separate lollipops defining the upper lid, as an alternative to the upper lid shown in FIG. 3.

FIG. 6 is a front elevational view showing two (2) separate lollipops defining the upper lid, as an alternative to the upper lid shown in FIG. 4.

FIG. 7 is a side elevational view of a hinged top version of a candy sucker according to the present invention with the lid in the closed position.

FIG. 8 is a side elevational view of a hinged top version of a candy sucker according to the present invention with the lid in the open position.

FIG. 9 is a side elevational view of a lollipop in combination with a candy sucker according to the present invention packaged together.

FIG. 10 is a side elevational view of another embodiment of the candy sucker according to the present invention.

FIG. 11 is a side elevational view of another embodiment of the candy sucker according to the present invention.

FIG. 12 is a front elevational view of another embodiment of the candy sucker according to the present invention.

FIG. 13 is a front elevational view of another embodiment of the candy sucker according to the present invention in the version of a shovel and pail.

FIG. 14 is a side elevational view of a candy sucker according to the present invention including a dinosaur head styled upper lid.

FIG. 15 is a side elevational view of another embodiment of the candy sucker according to the present invention including a “sports” theme such as a partial soccer ball defining an upper lid.

FIG. 16 is a side elevational view of a candy sucker according to the present invention having an “alien” theme with the upper lid secured to the container.

FIG. 17 is a side elevational view of a candy sucker according to the present invention having an alien theme with the upper lid separated from the container.

FIG. 18 is a front elevational view of a candy sucker according to the present invention including an insect object defining a portion of the upper lid.

FIG. 19 is a front elevational view of a candy sucker according to the present invention in the configuration of a rocket ship.

FIG. 20 is a side elevational view of a candy sucker according to the present invention wherein the sucker is thumb-shaped.

FIG. 21 is a side elevational view of the candy sucker shown in FIG. 20, however, with the thumb-shaped sucker disposed within the container.

FIG. 22 is a side elevational view of an alternative embodiment to the one shown in FIGS. 20 and 21, with a thumb-shaped lollipop.

FIG. 23 is a perspective view of a candy sucker having a “basketball” theme with the candy sucker to be connected to the outside of the container.

FIG. 24 is a perspective view of the embodiment of the candy sucker as shown in FIG. 23, with the lid portion open and the candy sucker about to be disposed therein.

FIG. 25 is a front elevational view of a candy sucker according to the present invention showing a “basketball” theme with a basket and backboard mounted on a base.

FIG. 26 is a side elevational view of the “basketball” theme shown in FIG. 25.

FIG. 27 is a front elevational view of a candy sucker according to the present invention imitating an oyster.

FIG. 28 is a side elevational view of a candy sucker article according to the present invention configured to simulate an ice cream cone.

FIG. 29 is a side elevational view of the article shown in FIG. 28, with a top portion of the container removed.

FIG. 30 is a side elevational view of another embodiment of the article shown in FIG. 28 configured to simulate an ice cream cone.

FIG. 31 is a side elevational view of the candy sucker article shown in FIG. 30 with a top portion of the container separated from a lower portion of the container.

FIG. 32 is a side elevational view of an embodiment of the candy sucker article according to the present invention configured to simulate a sundae.

FIG. 33 is a side elevational view of the candy sucker article shown in FIG. 32 with an upper portion of the container removed from a lower portion of the container.

FIG. 34 is a side elevational view of an embodiment of the candy sucker article according to the present invention configured to simulate an ice cream sundae.

FIG. 35 is a side elevational view of the candy sucker article shown in FIG. 34 with an upper portion of the container removed from a lower portion of the container.

FIG. 36 is a side elevational view of an embodiment of the candy sucker article according to the present invention configured to simulate a character such as a Mandrake™.

FIG. 37 is a side elevational view of the candy sucker article shown in FIG. 36 with the top portion of the container including the character removed from a lower portion of the container.

FIG. 38 is a perspective view of a candy sucker article according to the present invention configured to simulate a bear and honey pot in combination with a lollipop.

FIG. 39 is a perspective view of the candy sucker article shown in FIG. 38 with a lid of the container connected to the lollipop removed therefrom.

FIG. 40 is a perspective view of a candy sucker article according to the present invention showing a star-shaped container connected to a stick-shaped lollipop.

FIG. 41 is a side elevational view of the candy sucker article shown in FIG. 40 with the stick-shaped lollipop removed from the container.

FIG. 42 is a perspective view of a candy sucker article according to the present invention with a star-shaped container with a lollipop located therein.

FIG. 43 is a side elevational view of the candy sucker article shown in FIG. 42 with the lollipop removed from the container.

FIG. 44 is a side elevational view of a candy sucker article according to the present invention configured to simulate an apple.

FIG. 45 is a side elevational view of a candy sucker article according to the present invention configured to simulate an hourglass.

FIG. 46 is a perspective view of an embodiment of the candy sucker device according to the present invention with a candy sucker disposed within the container in a closed position.

FIG. 47 is a perspective view of an embodiment of the candy sucker device according to the present invention with a candy sucker disposed within the container in an open position.

FIG. 48 is a perspective view of an embodiment of the candy sucker device according to the present invention with a stick-shaped candy sucker located within a container.

FIG. 49 is a perspective view of the candy sucker article shown in FIG. 48 with the candy sucker extended therefrom.

FIG. 50 is a perspective view of an embodiment of the candy sucker article according to the present invention with a stick-shaped candy sucker located within the container.

FIG. 51 is a perspective view of the candy sucker article shown in FIG. 50 with the candy sucker extended therefrom.

FIG. 52 is a perspective view of a candy sucker device according to the present invention with a drill device connected to a lollipop connected to an upper portion of the container.

FIG. 53 is a broken away perspective view of the candy sucker article shown in FIG. 52 with the lollipop inserted within a lower portion of the container in contact with edible food product contained therein.

FIG. 54 is a perspective view of a candy sucker article according to the present invention with a candy drill connected to an upper portion of the container.

FIG. 55 is a perspective view of a candy sucker article according to the present invention with a rotatable lollipop disposed within a container.

FIG. 56 is a perspective view of a candy sucker article according to the present invention with a lollipop rotatably disposed within a container.

FIG. 57 is a perspective view of a candy sucker article according to the present invention with a lollipop rotatably disposed within a container.

FIG. 58 is a perspective view of a candy sucker article according to the present invention with a lollipop provided with a handle disposed within a bag type container.

FIG. 59 is a partial broken away cross-sectional view of the lollipop handle of the candy sucker article shown in FIG. 58.

FIG. 60 is a perspective view of a candy sucker article according to the present invention configured to simulate a toothbrush and holder.

FIG. 61 is a perspective view of the candy sucker article shown in FIG. 60 with the upper portion of the container partially removed.

FIG. 62 is a perspective view of a candy sucker article according to the present invention including a cone-shaped candy sucker mounted on a handle portion.

FIG. 63 is a vertical center cross-sectional view of the candy sucker article shown in FIG. 62.

FIG. 64 is a perspective view of a candy sucker article according to the present invention configured to simulate a sno-cone.

FIG. 65 is a perspective view of a candy sucker article according to the present invention including a wind-up mechanism for vibrating a handle connected to a candy sucker disposed within an upper container portion.

FIG. 66 is a perspective view of a candy sucker article according to the present invention configured to simulate a lipstick.

FIG. 67 is a perspective view of a candy sucker article according to the present invention configured to simulate a popsicle.

FIG. 68 is a perspective view of a candy sucker article according to the present invention with a stick-shaped lollipop having a handle portion inserted through a hole in an upper portion of a container.

FIG. 69 is a perspective view of the candy sucker article shown in FIG. 68 with the stick-shaped sucker removed from the container.

FIG. 70 is a perspective view of a candy sucker article according to the present invention configured to simulate a safe.

FIG. 71 is a perspective view of a candy sucker device according to the present invention configured to simulate a pencil and pencil sharpener.

FIG. 72 is a perspective view of a candy sucker article according to the present invention configured to simulate a flag and flag pole.

FIG. 73 is a perspective view of a candy sucker article according to the present invention configured to simulate an egg.

FIG. 74 is a perspective view of a candy sucker article according to the present invention configured to simulate a dolphin diving into a fish tank.

FIG. 75 is a perspective view of a candy sucker article according to the present invention configured to spin a lollipop.

FIG. 76 is a perspective view of a candy sucker article according to the present invention configured to simulate a drill.

FIG. 77 is a perspective view of a candy sucker article according to the present invention configured to spin a candy sucker.

FIG. 78 is a vertical center cross-sectional view of the candy sucker article shown in FIG. 77.

FIG. 79 is a perspective view of a candy sucker article according to the present invention configured to simulate a baby pacifier.

FIG. 80 is perspective view of a candy sucker article according to the present invention configured with edible food product located with a hard candy sucker.

FIG. 81 is a perspective view of a candy sucker article according to the present invention with multiple chambers configured for containing edible food product.

FIG. 82 is a vertical center cross-sectional view of the candy sucker article shown in FIG. 81.

FIG. 83 is a perspective view of a candy sucker article according to the present invention configured to spin a lollipop within a container configured to store edible food product.

FIG. 84 is a perspective view of a candy sucker article according to the present invention configured with a gyro to spin a lollipop within a container configured to store edible food product.

FIG. 85 is a perspective view of a candy sucker article according to the present invention provided with a lid configured to reciprocate a candy sucker up and down within a container configured to store edible food product.

FIG. 86 is a perspective view of a candy sucker article according to the present invention provided with a removable handle configured to spin a lollipop by pushing a button on the lid downwardly.

FIG. 87 is a perspective view of a candy sucker article according to the present invention configured to simulate a medal or coin.

FIG. 88 is a perspective view of a candy sucker article according to the present invention configured to simulate a gem ring.

FIG. 89 is a vertical center cross-sectional view of the candy sucker article shown in FIG. 88.

FIG. 90 is a front elevational view of a candy sucker article according to the present invention configured to simulate a necklace.

FIG. 91 is a perspective view of a candy sucker article according to the present invention having an upper lid and hard candy sucker configured to simulate a spoon.

FIG. 92 is perspective view of a candy sucker article with a manually operated mechanism according to the present invention configured to spin a lollipop by pressing a button.

FIG. 93 is a front elevational view of a candy sucker article according to the present invention configured to simulate a pen in a closed configuration.

FIG. 94 is a front elevational view of a candy sucker article shown in FIG. 93 in an open configuration.

FIG. 95 is a top elevational view of a candy sucker article according to the present invention configured to simulate a spacecraft or spaceship in a closed configuration.

FIG. 96 is a top elevational view of the candy sucker article shown in FIG. 95 in a partially open configuration.

FIG. 97 is a side elevational view of a candy sucker article according to the present invention with a spring load lollipop disposed therein in a closed configuration.

FIG. 98 is a side elevational view of the candy sucker article shown in FIG. 98 in an open configuration.

FIG. 99 is a side elevational view of a candy sucker article according to the present invention having multiple hard candy suckers.

FIG. 100 is a top planar view of the candy sucker article shown in FIG. 99.

FIG. 101 is a perspective view of the candy sucker article shown in FIGS. 99 and 100.

FIG. 102 is a side elevational view of a candy sucker article according to the present invention with a lollipop releasably connected to a container thereof.

FIG. 103 is a side elevational view of a candy sucker article according to the present invention shown with the lollipop detached from the container.

FIG. 104 is a side elevational view of the candy sucker article shown in FIG. 103 with the lollipop about to be inserted into the container.

### DETAILED DESCRIPTION OF PREFERRED EMBODIMENTS

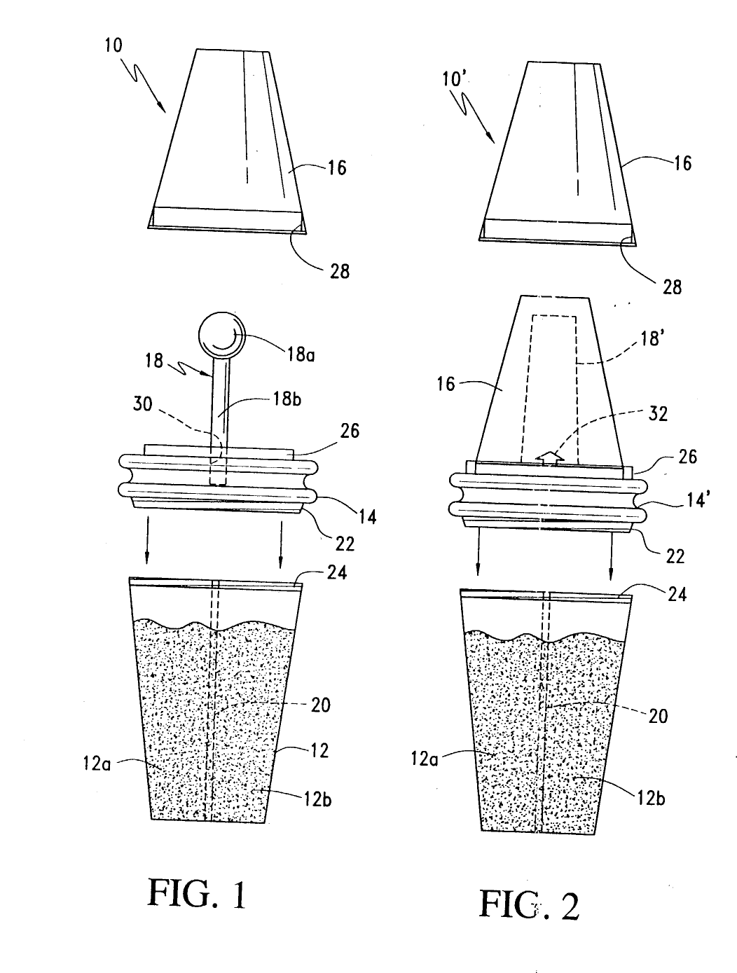

A preferred embodiment of a candy sucker 10 according to the present invention is shown in FIG. 1.

The candy sucker 10 includes a lower container 12, a removable upper lid 14, a removable cover 16 and a removable lollipop 18. The lower container 12 is split into two compartments 12a and 12b by a dividing wall 20. The upper lid 14 is removable from the lower container 12 by the threaded connection defined by the outer threaded flange 22 of the upper lid 14 cooperating with the inner threaded edge 24 of the lower container 12. A snap fit connection is provided between the removable cover 16 and upper lid 14. Specifically, the upper lid 14 is provided with a flange 26 cooperating with an inner sleeve 28 of the removable cover 16, with an interference type connection therebetween.

In this particular embodiment, the lollipop 18 is removable from the upper lid 14. Specifically, the lollipop 18 is defined by the hard candy portion 18a connected to the stick portion 18b, and the free end of the stick portion 18b is disposed within an aperture 30 on the upper surface of the upper lid 14. The free end of the stick portion 18b and the diameter and shape of the aperture 30 are selected so as to provide a slight interference fit therebetween so that the sucker is removable, however, remains connected during use.

An alternative to the embodiment as shown in FIG. 1, is shown in FIG. 2.

The candy sucker 10′ utilizes the same lower container 12 and removable cover 16, however, the upper lid 14′ has been modified so that the lollipop 18′ is directly connected to the lid portion. Specifically, the upper lid 14′ is provided with a protrusion 32 extending upwardly to connect with a lower portion of the lollipop 18′. For example, the protrusion 32 can be injection molded with the upper lid 14 out of a plastic material, and then the lollipop 18 is molded around the protrusion 32.

In the embodiment shown in FIGS. 1 and 2, a single lollipop is utilized with a container having two separate compartments. The two separate compartments 12a and 12b can contain food, in particular powdered or granular candy. The two separate compartments can contain the same or different flavored powdered or granular candy to allow for different flavoring. The powder or granular candy can have different colors and the lower container 12 and removable cover 16 can be clear or translucent to allow a user to view the various colored candy products contained in this particular package. Alternatively, the two separate compartments can be replaced with three or more separate compartments to further add a variety of flavors and/or colors.

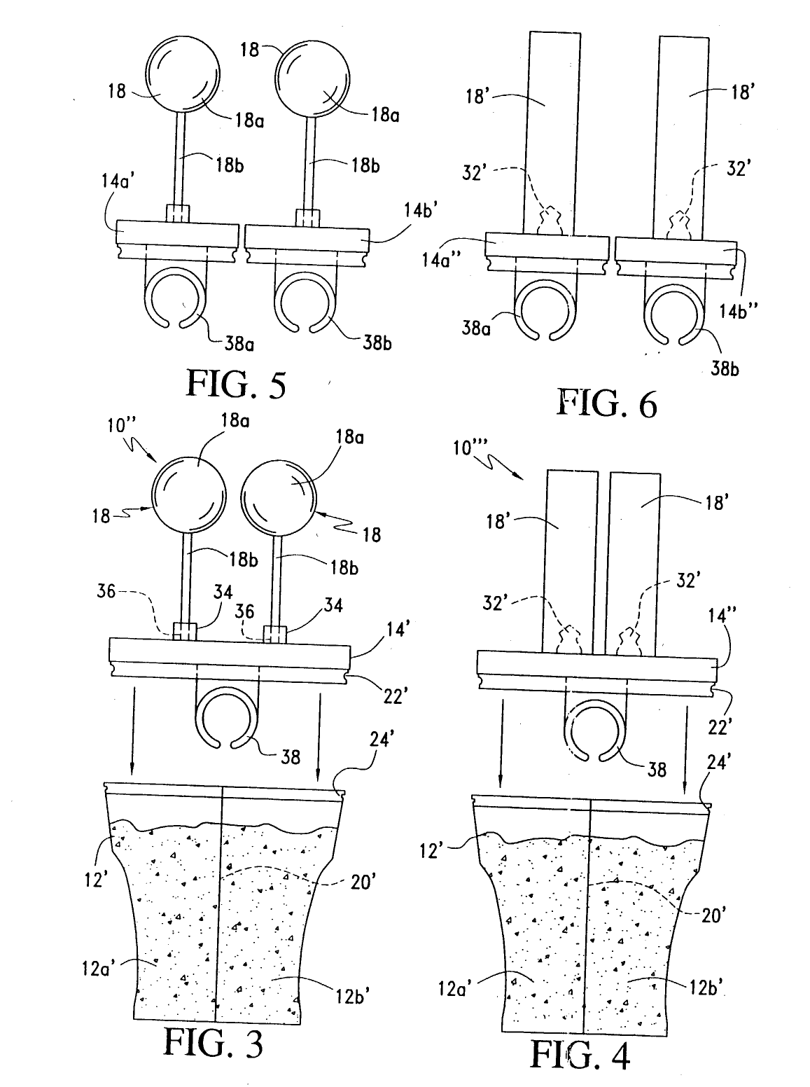

Further embodiments of the candy sucker according to the present invention are shown in FIGS. 3 and 4.

The embodiment shown in FIG. 3, a pair of spaced apart lollipops 18 are releasably connected to the upper lid 14′. The upper lid 14′ is provided with a pair of spaced apart protrusions 34 each having an aperture 36 for receiving the free end of the stick portion 18b of lollipops 18. A finger grip portion 38 extends downwardly from the upper lid 14′. In the embodiment shown in FIG. 4, the lollipops 18′ are directly connected to the upper lid 14′ by a pair of spaced apart protrusions 32′.

As shown in FIGS. 5 and 6, the upper lid shown in FIGS. 3 and 4 has been split into separate upper lid portions 14a′ and 14b′. In the embodiment shown in FIG. 6, the upper lid 14″ shown in FIG. 4 has been split into two separate upper lid portions 14a″ and 14b″. In the embodiment shown in FIGS. 3 and 4, when the upper lid 14′ is removed, both compartments 12a′ and 12b′ are accessible to the lollipops 18. In the embodiments shown in FIGS. 5 and 6, the upper lid portions 14a′, 14b′, 14a″ and 14b″ can be selectively removed from the lower containers 12′ respectively, so that the compartments 12a′ and 12b′ can be selectively accessed by the lollipops 18.

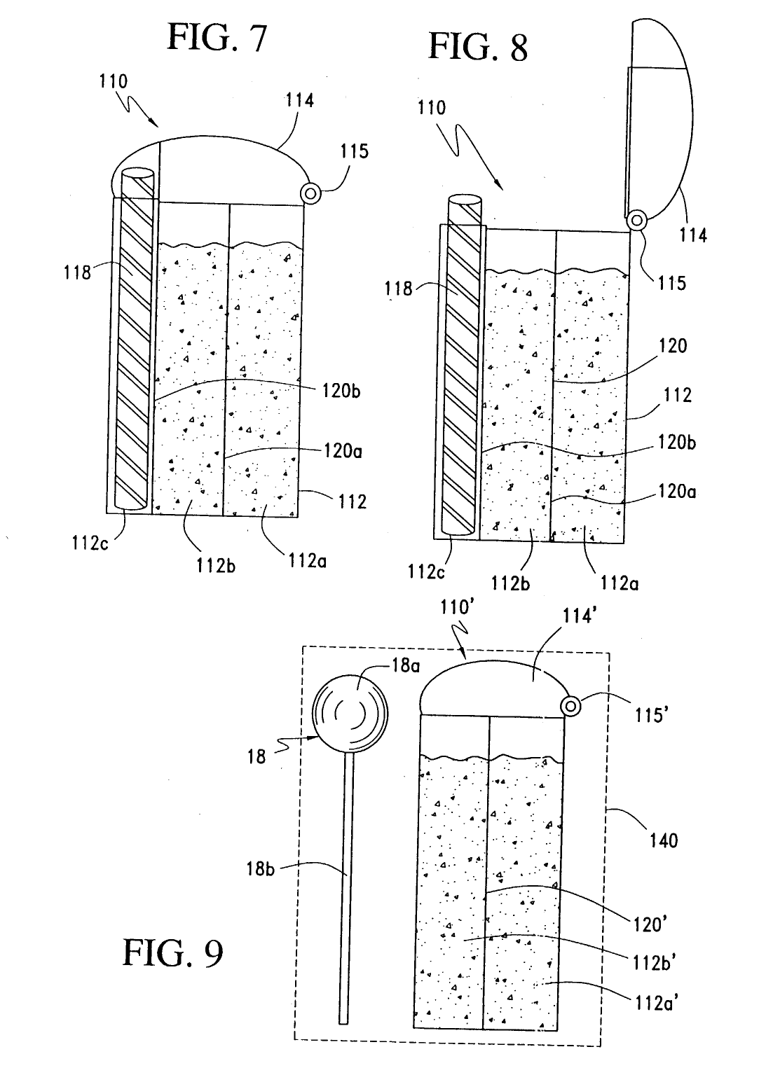

An even further embodiment of the present invention is shown in FIGS. 7, 8 and 9.

In the embodiment shown in FIGS. 7 and 8, a lower container 112 is connected to an upper lid 114 by a hinge 115 (e.g. live hinge or multi-component hinge). The lower container 112 is split into three (3) separate compartments 112a, 112b and 112c. For example, the compartments 112a and 112b can contain a powdered or granulated fruit product or candy. A separate hard candy 118 (e.g. candy cane) can be stored in the third separate compartment 12c. The upper lid 114 is opened to allow a user to remove the hard candy 118 and dip same in one or both separate compartments 12a and 12b. Alternatively, the lower container 112′ can be two (2) separate compartments, as shown in FIG. 9, and a lollipop 18 is shown packaged (indicated by dashed lines) with the assembled unit defined by the lower container 112′ and the upper lid 114′. The package 140 can be a wide variety of different packaging, including a paper box, a plastic see-through container, shrink wrapping, blister packing or any other type of suitable packaging to associate the lollipop 18 with the assembled container. In the embodiment shown in FIGS. 7 and 8, the separate compartments are defined by dividing walls 120a and 120b. In the embodiment shown in FIG. 9, the compartments 112a′ and 112b′ are defined by dividing wall 120′.

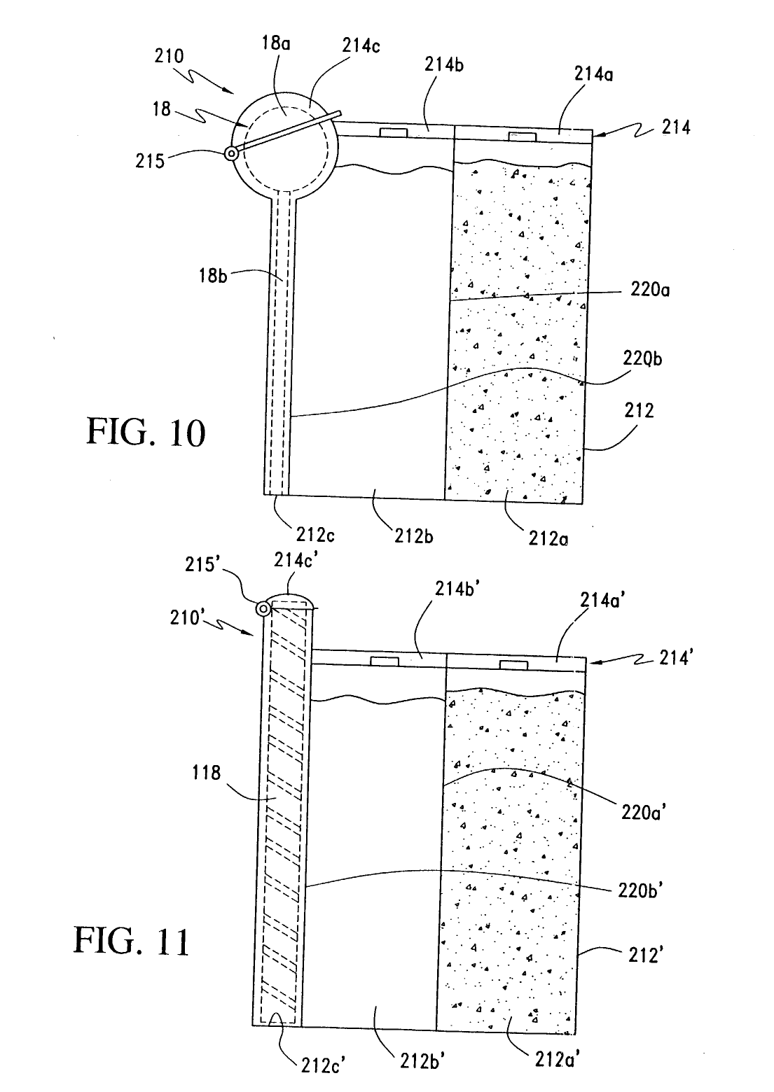

Additional embodiments similar to one shown in FIGS. 7-9 are shown in FIGS. 10 and 11. The embodiment shown in FIG. 10, the upper lid 214 is divided into three (3) separate upper lid portions 214a, 214b and 214c. The upper lid portions 214a and 214b can be hinged to the lower container 212, or fully removable. The upper lid portions 214c is connected to the lower container 212 by hinge 215. In the embodiment in FIG. 11, the upper lid 214′ is split into three (3) separate upper lid portions 214a′, 214b′ and 214c′. The lid portions 214a′ and 214b′ can be hinged to the lower housing 212′ or fully removable. The upper lid portion 214c′ is connected to the lower container 212′ by hinge 215′.

In the embodiment shown in FIGS. 7-9, the compartments containing the powdered or granulated food or candy become simultaneously accessible upon opening the lid 114 and 114′, respectively. In the embodiment shown in FIGS. 10 and 11, the upper lid portions 214a, 214b, 214c, 214a′, 214b′ and 214c′ can be selectively opened to provide selective access to the various compartments.

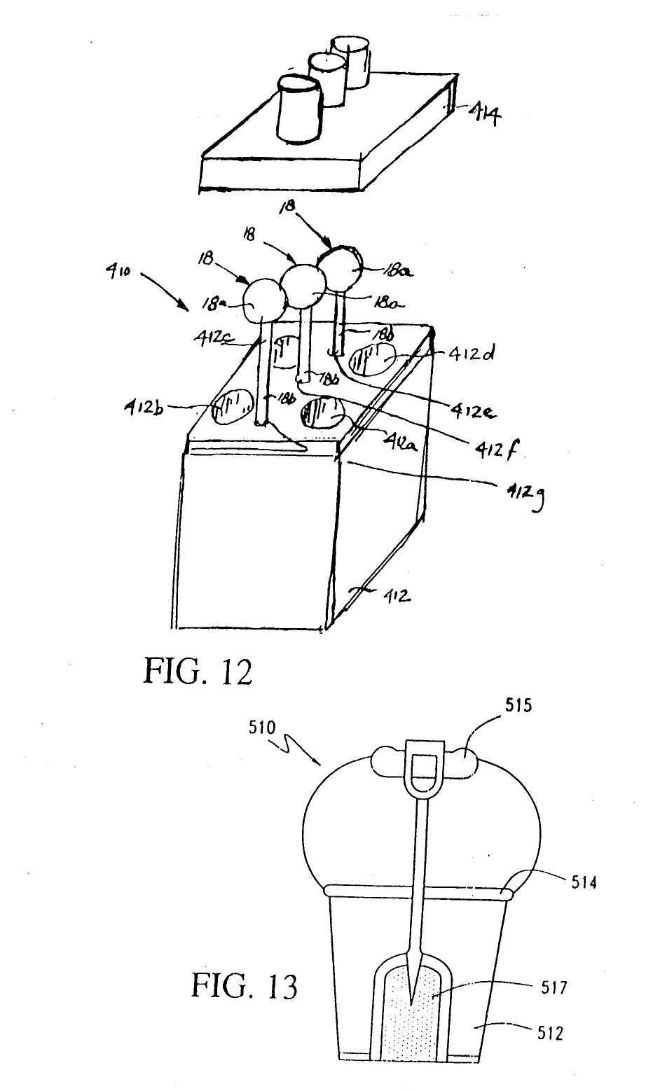

Another embodiment of the candy sucker 410 according to the present invention is shown in FIG. 12 similar in format to a “LEGO” block. In this particular embodiment, the container 412 is provided with four (4) compartments 412a, 412b, 412c and 412d and a removable lid 414. The container 412 is also provided with compartments 412e, 412f and 412g to provide holders for the three (3) suckers as shown. In this particular embodiment, the container 412 is a single piece with the compartments 412a, 412b, 412c and 412d provided therein. For example, the container 412 can be made of injection molded plastic.

The candy sucker according to the present invention can have various formats. For example, as shown in FIG. 13, the candy sucker 510 includes a lower container 512 and an upper lid 514. The container 512 is provided with a handle 515 to which a hard candy shovel 517 is releasably connected. A user grips the shovel 517 and removes it from the handle 515 and then removes the upper lid 514 to provide access.

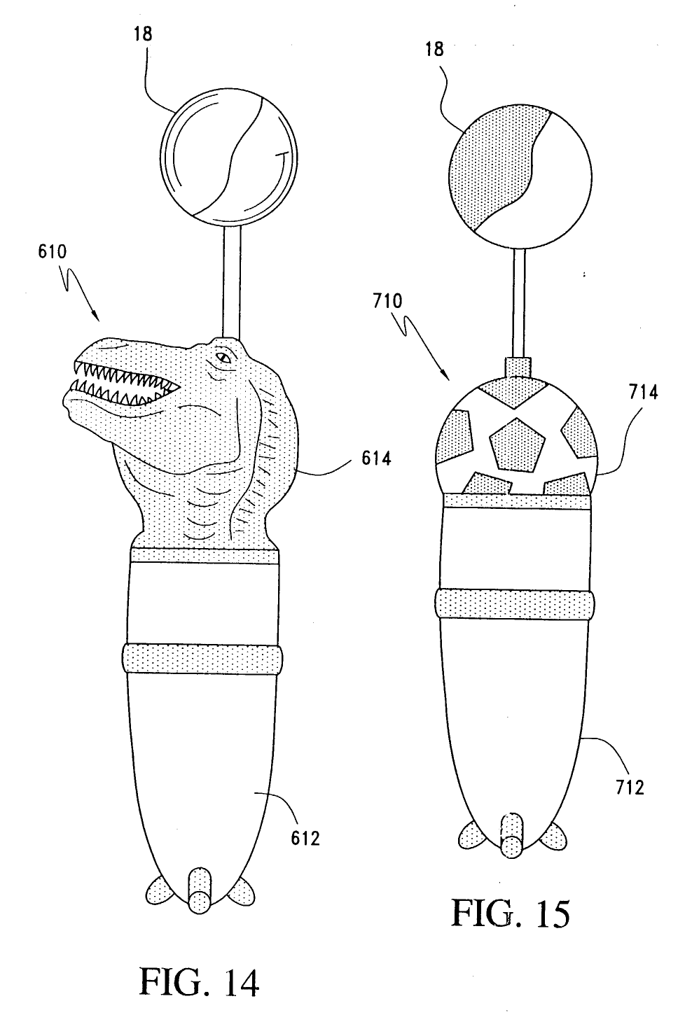

A “character” version of the candy sucker according to the present invention is shown in FIG. 14. In this embodiment, the candy sucker 610 includes a lower container 612 and an upper lid 614. The upper lid is configured to be the head of a dinosaur. In the embodiment shown in FIG. 15, the upper lid 714 is configured to exhibit a portion of a soccer ball.

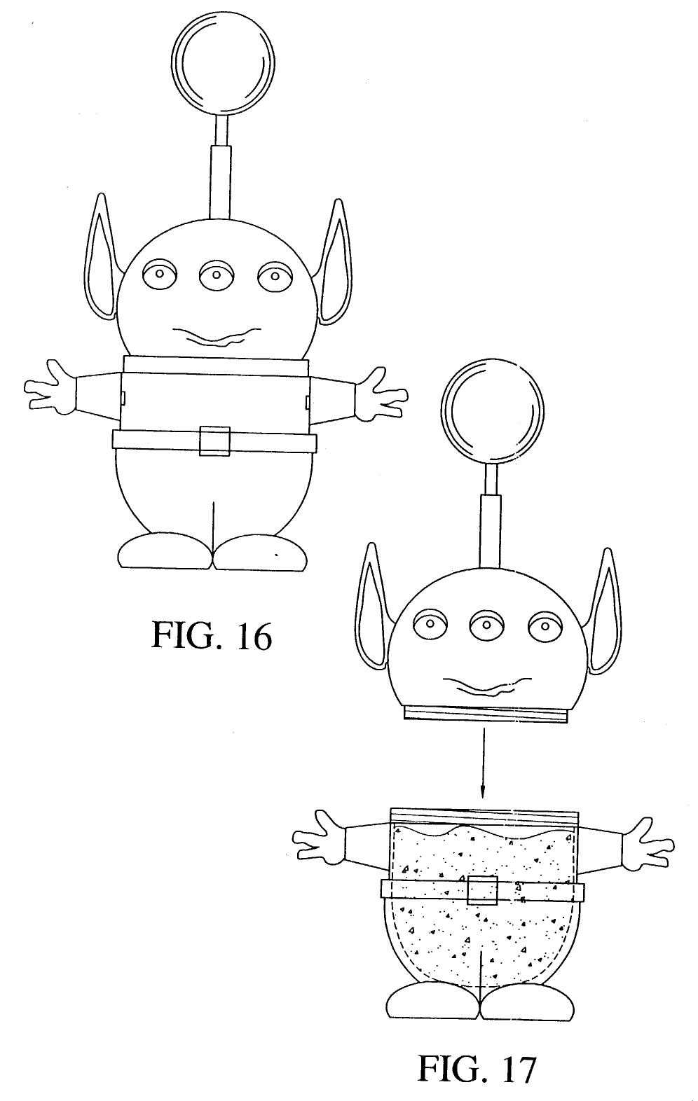

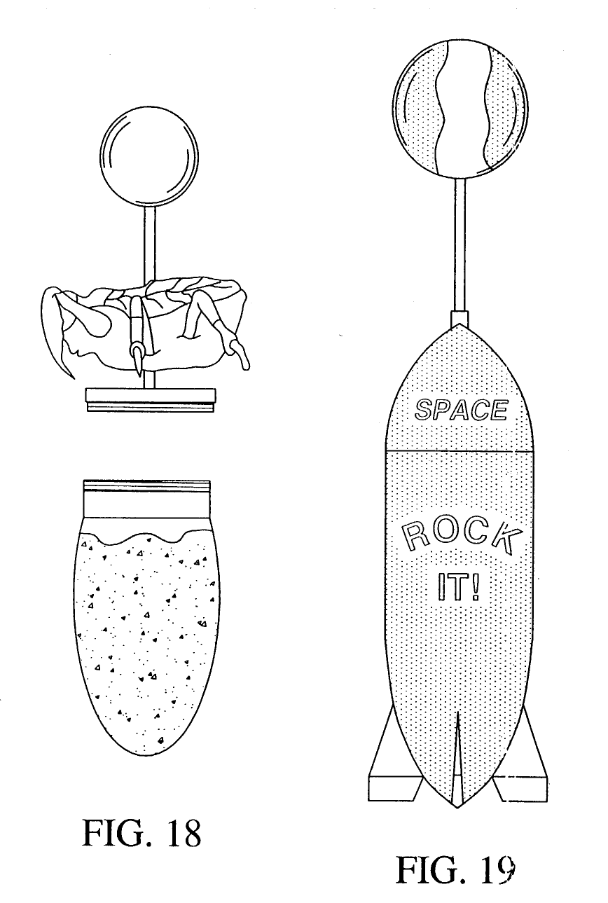

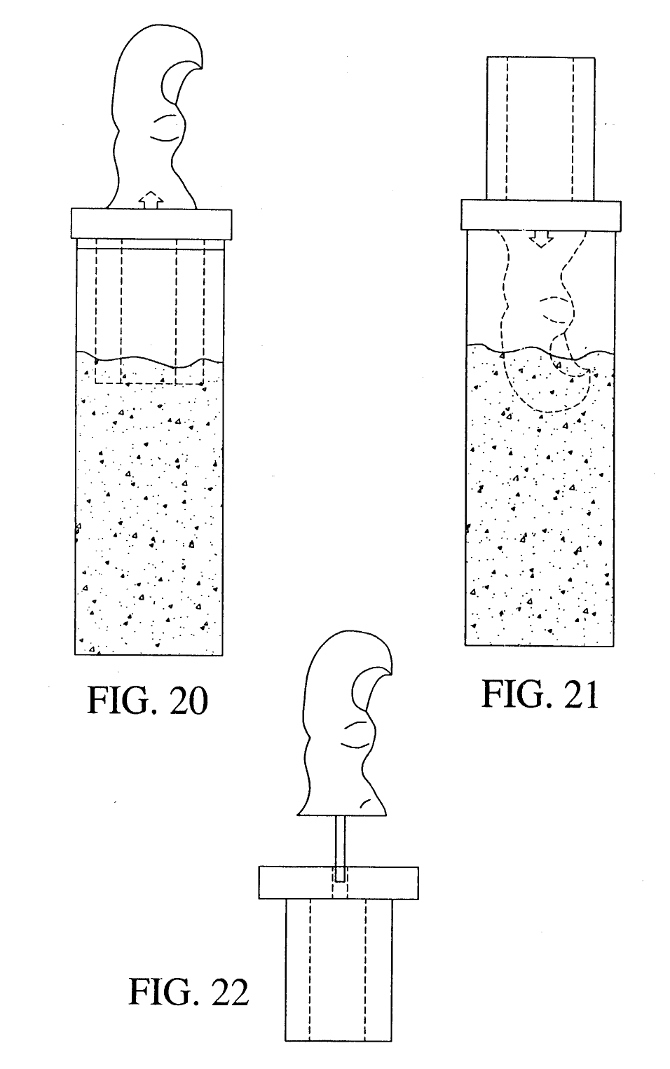

FIGS. 16 and 17 show an embodiment of the candy sucker according to the present invention using an “alien” figure. In the embodiment shown in FIG. 18, an insect figure is incorporated with the lid portion. In FIG. 19, the container is configured to be a rocket ship, and in FIGS. 20-22, the hard candy sucker is “thumb” shaped.

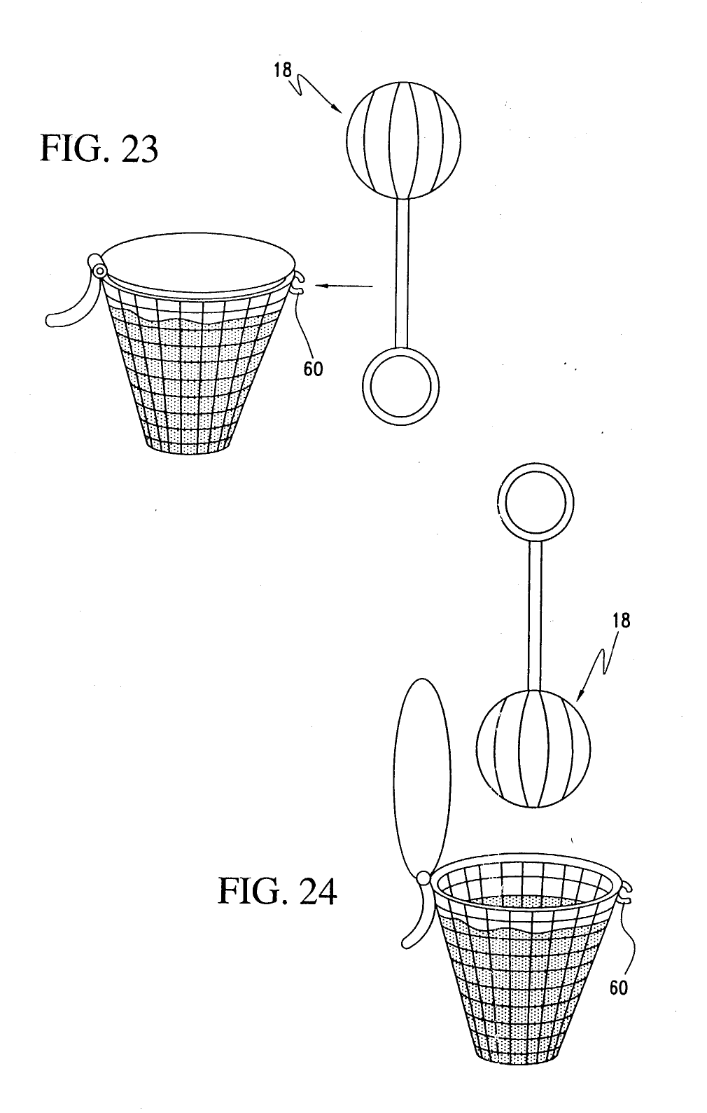

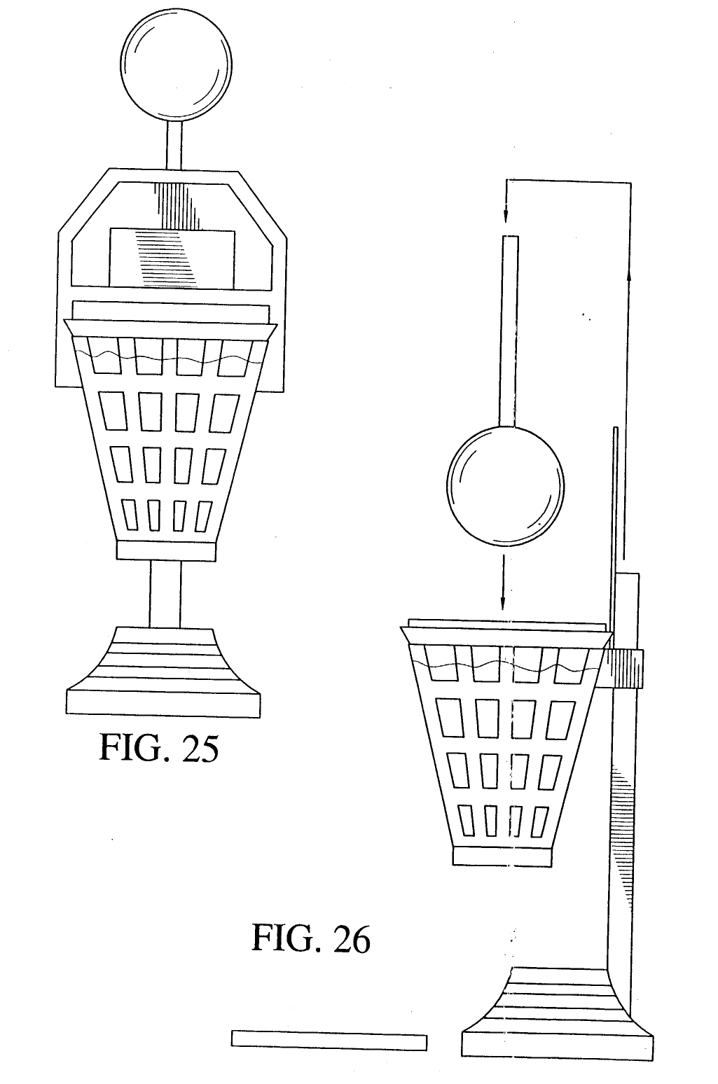

In FIGS. 23 and 24, a basketball-shaped sucker in combination with a basket styled container provide for a “basketball” theme. The sucker 18 can be clipped via the connector 60 to the container. In an alternative to the “basketball” theme shown in FIGS. 23 and 24, is the candy sucker shown in FIGS. 25 and 26. In this embodiment, the container is a basket and the sucker is attached to the backboard supported on a stand. Another embodiment is shown in FIG. 27 to look like an “oyster” with a circular-shaped candy used to dip within powder or granular candy contained within the shell portion.

A preferred embodiment of the candy sucker according to the present invention is preferably configured to simulate an ice product (e.g. snow cone, ice pop) or ice cream product (e.g. ice cream cone, sundae, ice cream bar). Specifically, the candy sucker according to the present invention can be configured to simulate an ice cream cone, ice cream scoop, ice cream sundae, ice cream bar, ice cream sandwich, ice cream pop, ice cream Popsicle, ice pop, sno-cone.

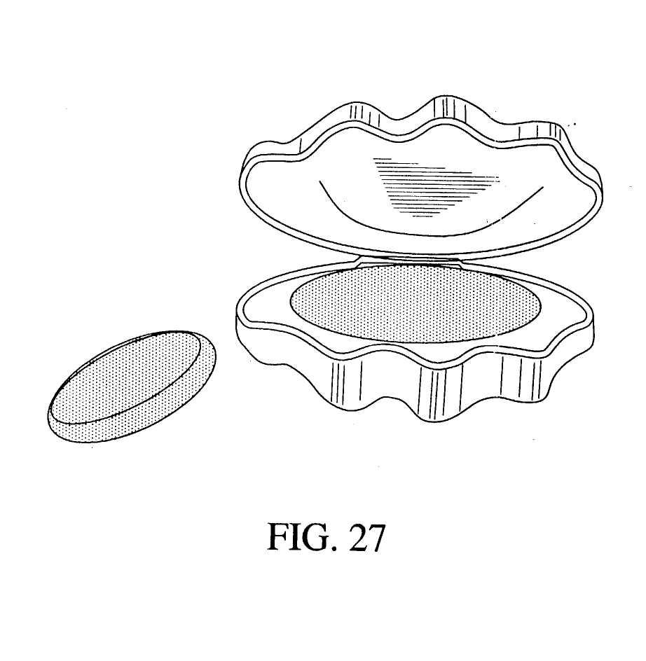

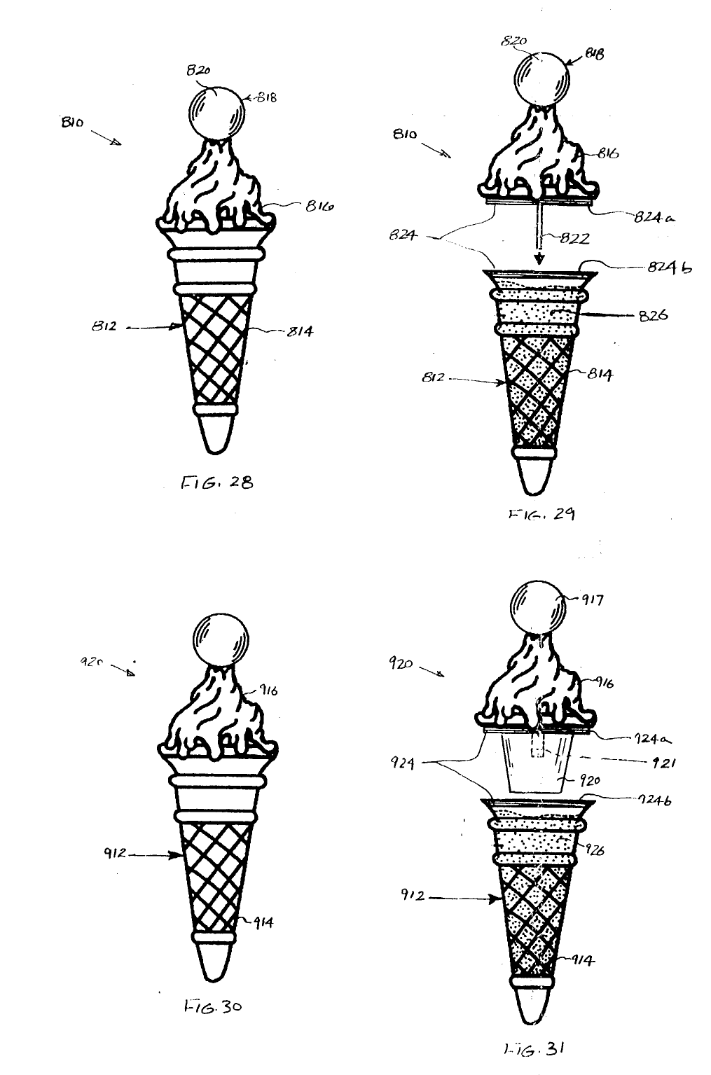

As shown in FIGS. 28 and 29, the candy sucker 810 is configured to simulate an ice cream cone. Specifically, a container 812 includes a lower portion 814 configured to simulate a cone and an upper portion 816 configured to simulate an ice cream scoop. An optional cherry 818 can be simulated at the top of the upper portion 816. A lollipop 818 having a hard candy portion 820 configured to simulate a cherry is provided on the top of the upper container portion 816.

As shown in FIG. 29, the upper container portion or lid 816 is removably connected to the lower container portion 814. For example, a male connector portion 424a of the upper container portion 816 can cooperate with a female connector portion 824b located on the lower container portion 814. The connection 824, for example, can be a threaded connection, press fit, snapfit, lure lock or other suitable connection therebetween.

The lollipop 818 can be connected to the upper container portion 816 so as to not be removable (e.g. a use of press fit, adhesive, fastener or other suitable connection method) or the lollipop 818 and upper container portion 816 can be configured so that the lollipop 818 is removable and replaceable with another lollipop after consumption of the initial lollipop. Alternatively, the hard candy portion 820 can be directly molded on a stick-shaped portion or protrusion extending upwardly from the upper container portion 816 and the stick portion 822 can be molded as part of the upper container portion 816. Preferably, both the lower container portion 814 and upper container portion 816 are plastic injection molded parts. As a further alternative, both the upper container portion 816 and hard candy portion 820 are made as a single piece of hard candy molded on the upper end of the stick portion 822 or otherwise a large lollipop. The lower container portion 814 is at least partially filled with an edible food product 826 such as powdered candy product, particulate candy product, powdered sugar product, candy sprinkles, cookie crumbs, non-pariels, or other types of edible food products configured to adhere to the surface of a candy sucker once moisturized.

Another embodiment of a candy sucker 920 configured to look like an ice cream cone is shown in FIGS. 30 and 31.

The candy sucker 920 is similar to the candy sucker 810 shown in FIGS. 28 and 29, however, a hard candy sucker 920 extends from a lower portion of the upper container portion 916. For example, the upper container portion 916 is a plastic injection molded part having a downwardly extending protrusion 921 on which the candy sucker 920 is molded thereon. The lower container portion 914 is preferably a plastic injection molded part and configured to releasably connect with the upper container portion 916. In this embodiment, the upper container portion 916 is molded to simulate an ice cream scoop with a cherry 917 located on the top thereof. The simulated cherry 917 provides a handle or grip for a person using the candy sucker article 920.

Another embodiment of the candy sucker article 1010 according to the present invention is shown in FIGS. 32 and 33. The candy sucker article 1010 is essentially the same as the embodiment shown in FIGS. 28-31, except instead of simulating an ice cream cone the container 1012 is configured to simulate an ice cream sundae.

Another embodiment of the candy sucker article 1110 according to the present invention is shown in FIGS. 34 and 35. The candy sucker article 1110 is essentially the same as the embodiment shown in FIGS. 28-31, except instead of simulating an ice cream cone the container 1112 is configured to simulate an ice cream sundae.

Another embodiment of the candy sucker article 1210 according to the present invention is shown in FIGS. 36 and 37.

The candy sucker article 1210 includes a container 1212 having a lower container portion 1214, an upper container portion 1216. The lower container portion 1214 is configured to simulate a plant pot and the upper container portion 1216 is configured to simulate a plant. A figurine or character 1217 is connected within the upper container portion 1216 and hangs downwardly therefrom as shown in FIG. 37. For example, the character 1217 can be a Mandrake™.

The candy sucker article 1210 is configured to emit noise when the container 1212 is opened. Specifically, the candy sucker article 1210 is provided with a mechanical noise generator 1250 (e.g wind up mechanism). The mechanical noise generator 1250 is configured to activate upon activation of the mechanical switch 1254 when the upper container portion 1216 is removed from the lower container portion 1214. The character 1217 is a candy sucker and an edible food product 1226 is stored within the container 1212. The container 1212 is provided with an inner wall portion 1212a to maintain the mechanical noise generator 1250 separate from the contents of the reservoir 1212a.

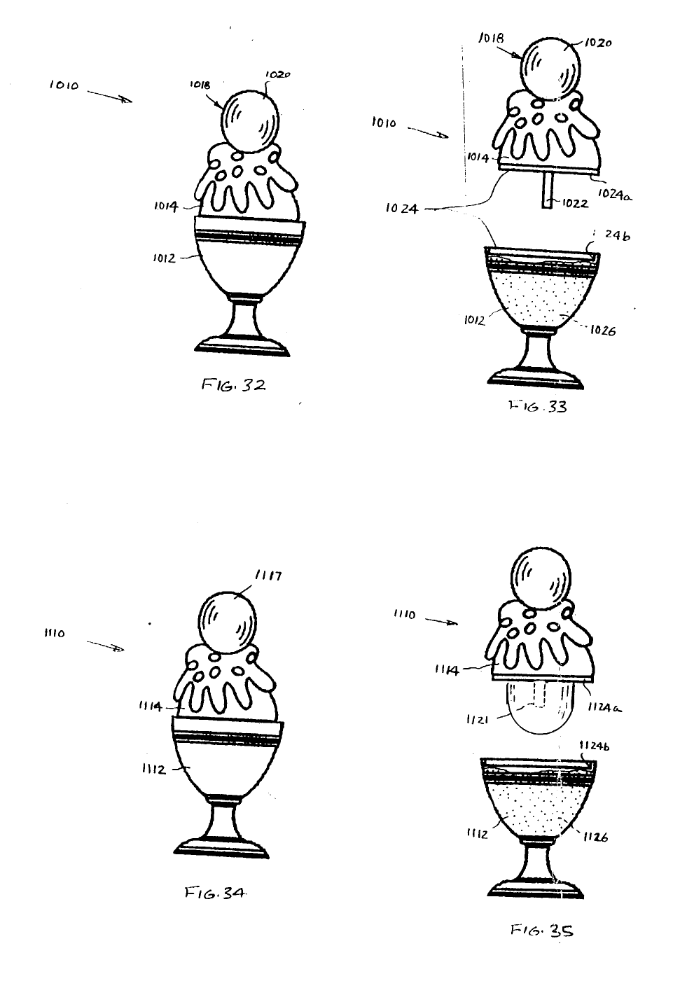

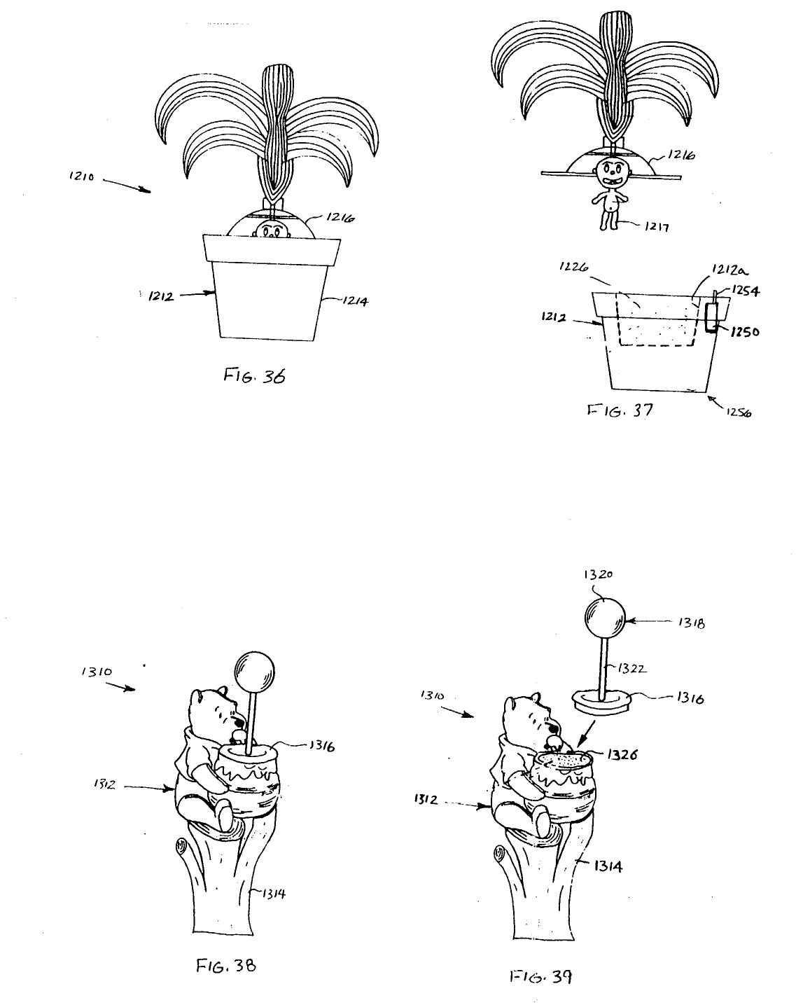

Another embodiment of the candy sucker article 1310 according to the present invention is shown in FIGS. 38 and 39.

The candy sucker article 1310 includes a container 1312 having a lower container portion 1314 and an upper container portion or lid 1316. The container 1312 is configured to simulate a character (e.g. cartoon character, movie character, comic book character or other character) such as a bear and honey pot shown.

A lollipop 1318 including a hard candy portion 1320 connected to a stick portion 1322 is connected to the upper container portion or lid 1316. The lollipop 1318 can be removably attached (e.g. by providing an aperture in an upper surface of the lid 1316), or can be substantially permanently connected. An edible food product 1326 is provided in the container 1312. A person using the candy sucker device 1310 licks the hard candy portion 1320 of the lollipop 1318, removes the lid 1316 from the container 1312, and then dips the hard candy portion 1320 into contact with the edible food portion 1326 to apply same to the outer surface of the hard candy portion 1320 of the lollipop 1318.

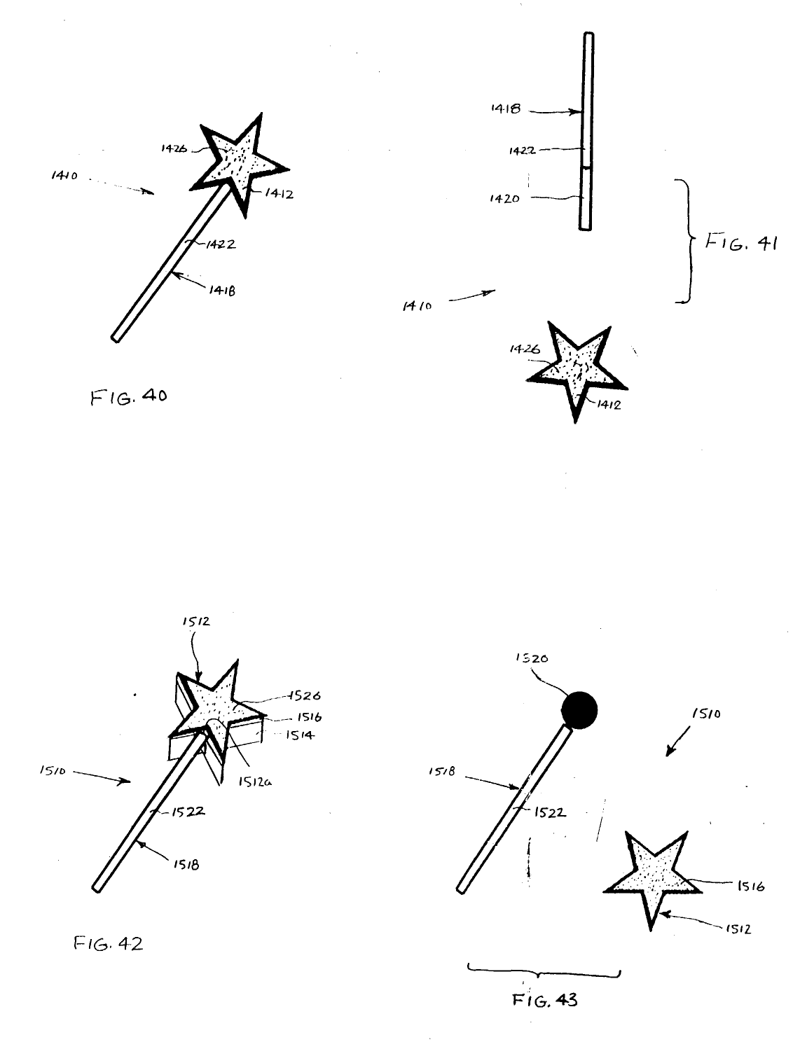

Another embodiment of the candy sucker article 1410 according to the present invention is shown in FIGS. 40 and 41.

The candy sucker article 1410 includes a specifically shaped container 1412 (e.g. star shaped, circle, triangle, rectangle, square, cube, trapezoid, parallelepiped, or other geometrical shape). A stick-shaped lollipop 1418 includes a hard candy portion 1420 and stick portion 1422. The container 1412 is provided with a through hole or aperture on the side thereof to allow the candy portion 1420 of the lollipop 1418 to be loaded into the container 1412. The container 1412 is configured to store an edible food product 1426.

Another embodiment of the candy sucker 1510 according to the present invention is shown in FIGS. 42 and 43.

The candy sucker article 1510 includes a container 1512 having a lower container portion 1514 and an upper portion or lid 1516. The lid 1516 is removable from the lower container portion 1514, and can be a separate part or connected by a hinge. A lollipop 1518 is connected to the container 1512. Specifically, the lollipop includes a hard candy portion 1520 disposed within the container 1512 and a stick portion 1522 extending from the container 1512 through a hole or aperture 1512a and the side thereof. A person using the candy sucker 1510 opens the lid 1516 of the container 1512 and removes the lollipop 1518 therefrom. The person licks the hard candy portion 1520 of the lollipop 1518, and then dips the hard candy portion 1520 into the edible food product 1526 stored within the container 1512.

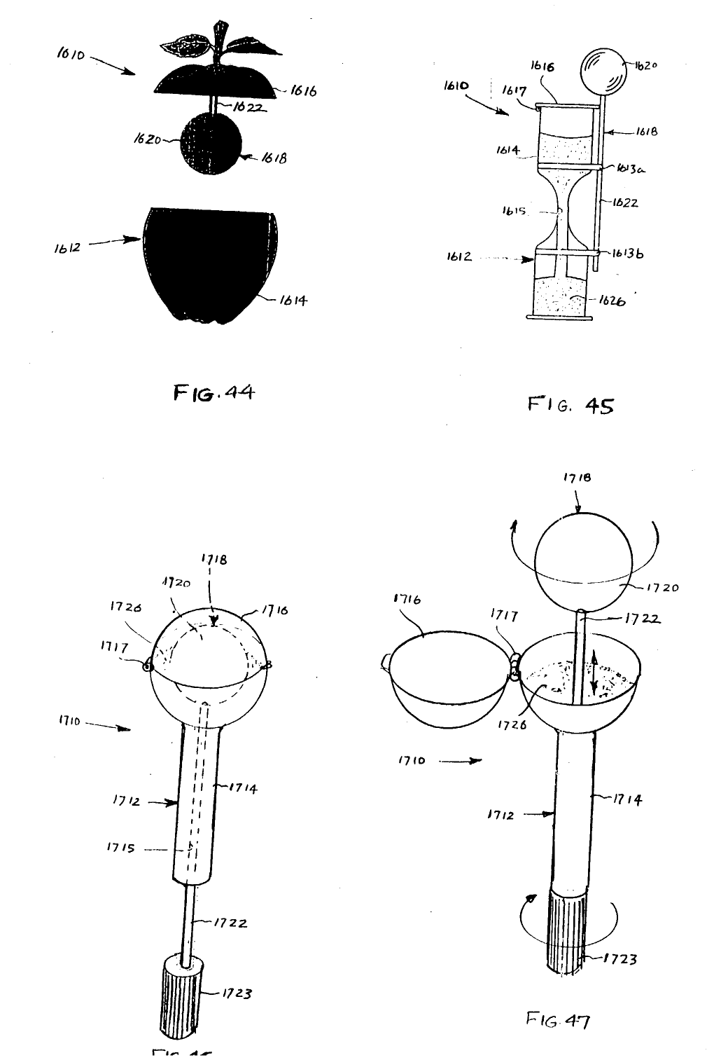

Another embodiment of the candy sucker article 1610 according to the present invention is shown in FIG. 44.

The candy sucker article 1610 is configured to simulate a fruit (e.g. apple, orange, pear, mango, cherry, lemon, lime, etc.). The candy sucker article 1610 includes a container 1612 having a lower container portion 1614 releasably connected to an upper container portion 1616. Preferably, the container 1612 is made from plastic injection molded parts. A lollipop 1618 is connected to a bottom portion of the upper container portion 1616, and extends downwardly therefrom. The lollipop 1618 includes a hard candy portion 1620 connected to a stick portion 1622. Another candy sucker article 1610 according to the present invention is shown in FIG. 45.

The candy sucker article 1610 includes a container 1612 configured to simulate an hourglass. The container 1612 includes a lower container portion 1614 connected to an upper container portion or lid 1616. The lid 1616 is connected to the lower container portion 1614 by hinge 1617.

A lollipop 1618 having a hard candy portion 1620 connected to a stick portion 1622 is releasably connected to the container 1612. For example, the container 1612 is provided with gripping portions 1613a and 1613b configured to releasably grip the stick 1622 of the lollipop 1620. The lower container portion 1614 is at least partially filled with an edible food product 1626, which can pass through a passageway 1615 when the candy sucker article 1610 is turned upside down to at least partially fill an upper portion of the lower container portion 1614 when the candy sucker article 1610 is turned upright. Preferably, the container 1612 is a clear or translucent plastic injection molded part to allow a person to watch the edible food product 1626 move or pour through the passageway 1615 during use. A user turns the candy sucker article 1610 upside down to at least partially fill an upper portion of the lower container portion 1614, lifts up the lid 1616 and then dips the hard candy portion 1620 of the lollipop 1618 into the opening into the top of the container 1614.

Another embodiment of a candy sucker article 1710 according to the present invention is shown in FIGS. 46 and 47.

The candy sucker article 1710 includes a container 1712 having a lower container portion 1714 connected to an upper container portion 1716 by a hinge 1717. Preferably the container 1712 is made of plastic injection molded parts. For example, the upper container portion 1716 can be a clear or translucent plastic injection molded part to allow a person to view the lollipop 1718 and edible food product 1726 contained therein. Further, the lower container portion 1714 can be an opaque plastic injection molded part or clear or translucent. In embodiments utilizing clear plastic material, the plastic material can be colored, colorless and/or tinted to provide various visual effects and appearances.

A grip 1723 (e.g. fingergrip or finger and thumb grip) is connected to a lower end of the stick portion 1722 of the lollipop 1718. Specifically, the container 1712 is provided with a through passageway 1715 for accommodating the stick portion 1722 of the lollipop 1718, and to allow both sliding of the stick portion 1722 upwardly and downwardly and rotating movement within the container 1712 as indicated in FIG. 47.

In use, a person grips the lower container portion 1714 with the fingers and thumb of one hand, and grabs the grip 1723 with the fingers and thumb of the other hand. The person then pushes upwardly on the grip 1723 while holding the lower container portion 1714 stationary causing the lollipop 1718 to raise and open the upper container portion or lid 1716 to the position shown in FIG. 47. The person licks the lollipop 1718, and then lowers the lollipop into contact with the edible food product 1726 to apply same onto an outer surface of the hard candy portion 1720 of the lollipop 1718. The person then again raises the lollipop 1718 from within the container 1712 to provide access for again licking. The upper container portion 1716 can be spring loaded to automatically open and close with movement of the lollipop 1718 upwardly and downwardly relative to the container 1712. Alternatively, the upper container portion or lid 1716 can be freely hinged to open and close by gripping with the finger and thumb of a person using the candy sucker article 1710. Preferably, the upper container portion 1716 can positively connect or lock with the lower container portion 1714 in the “closed” position (e.g. by providing an interference fit or snap-fit connection) to insure that the edible food product 1726 remains within the container 1712 when the candy sucker article 1710 is not in use to prevent spills.

Another embodiment of the candy sucker article 1810 according to the present invention is shown in FIGS. 48 and 49.

The candy sucker article 1810 includes a container 1812 having a lower container portion 1814 and a removable upper container portion or lid 1816. For example, the removable lid 1816 can be a removable snap cap or twist on/off closure. A hard candy sucker 1820 is disposed within the container 1812 and is connected to grip 1823. Specifically, the grip 1823 includes a shaft portion 1823a connected to a sleeve portion 1823b configured to receive a lower end of the candy sucker 1820 therein. The grip 1823 and the candy sucker 1820 are configured to both slidably move upwardly and downwardly and rotate within a through passageway 1815 of the container 1812. During use, a person removes the lid 1816 and presses upwardly on the grip 1823 while holding stationary the container 1812. The candy sucker 1820 extends from the top of the container 1812, as shown in FIG. 49, to allow a person to lick a top portion of the candy sucker 1820. The person then lowers the upper end of the candy sucker 1820 back into the container 1812 by pulling downwardly on the grip 1823, and then rotates the grip 1823 to rotate the candy sucker 1820 within the container 1812 to apply edible food product 1826 to an outer surface of the candy sucker 1820. The person then pushes upwardly on the grip 1823 to raise and extend the upper portion of the candy sucker 1820 out of the container 1812 to allow further licking.

Another embodiment of the candy sucker article 1910 according to the present invention is shown in FIGS. 50 and 51.

The candy sucker article 1910 includes a container 1912 having a lower container portion 1914 connected to an upper container portion or lid 1916 by a live hinge 1917, as shown in FIG. 51. The container 1912 is a multiple chamber container having four (4) separate chambers 1912a, 1912b, 1912c and 1912d. The four (4) separate chambers 1912a-d can contain the same or different edible food products 1926a-d. For example, the chamber 1912a-d can contain four (4) different flavored and/or types of edible food product 1926a-d. The candy sucker 1920 is shown as being cylindrically-shaped, and extends through the middle of the container 1912. The inside of the container 1912 is provided with four (4) separate flanges 1914a-d that extend radially inwardly and end at the cylindrical-shaped surface of the candy sucker 1920 to somewhat seal the separate chambers 1912a-d from each other. This prevents the movement of different flavored edible food product 1926a-d from one chamber to the next during upward and downward or rotating movement of the candy sucker 1920 within the container 1912. In use, a person pushes upwardly the grip 1923 while holding the container 1912 stationary forcing the lid 1916 upwardly with the end of the candy sucker 1920. The person then licks the upper end of the candy sucker 1920, and lowers the candy 1920 back into the container 1912 by pulling downwardly on the grip 1923. The outer surface of the upper end of the candy sucker 1920 is coated by the edible food product 1926a-d in essentially four (4) quadrants on the outer cylindrical-shaped surface of the candy sucker 1920. The person then pushes upwardly on the grip 1923 to raise the candy sucker 1920 out of the container 1912 to allow further licking thereof.

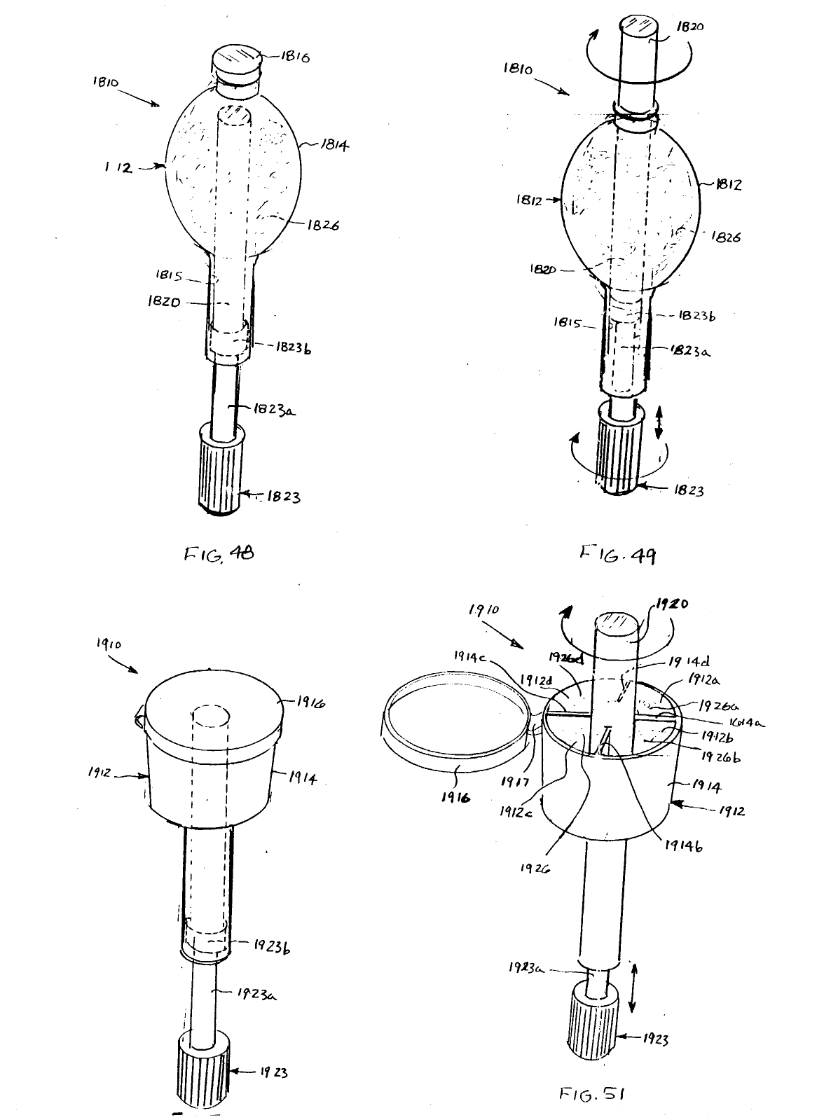

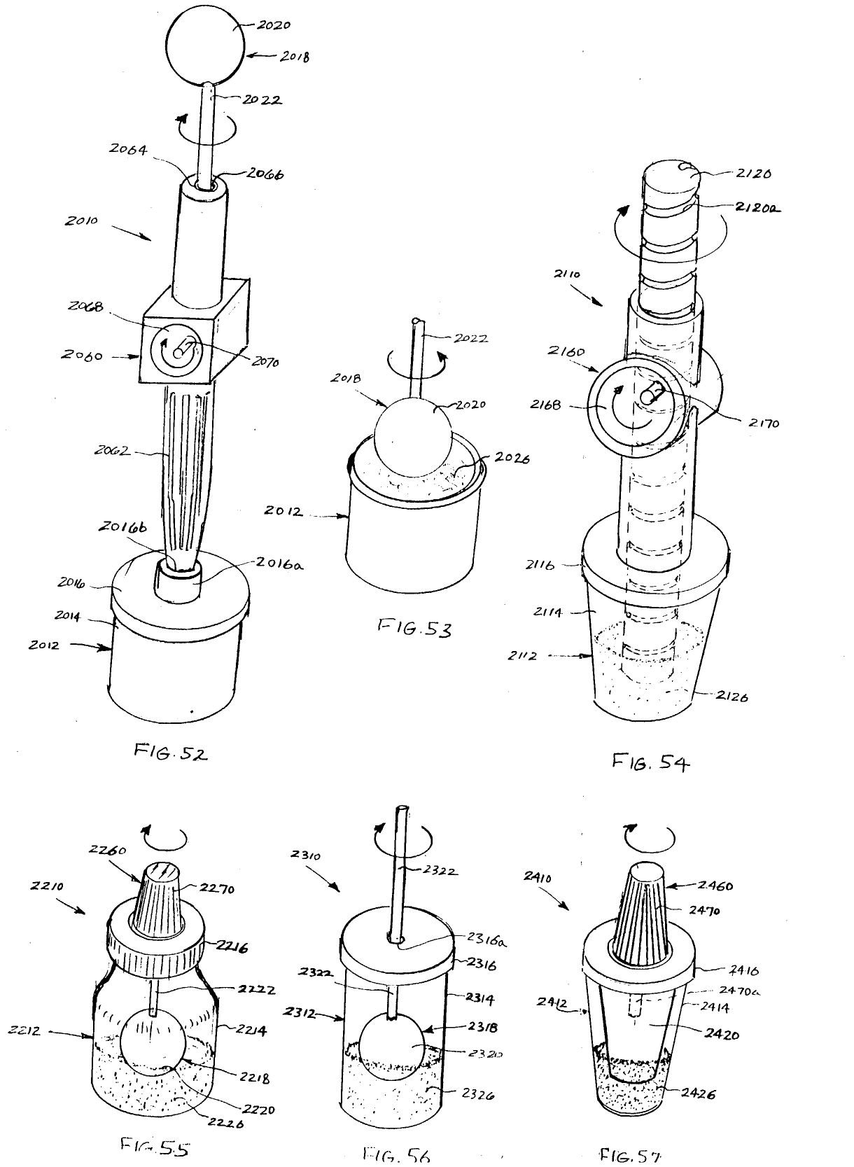

Another embodiment of the candy sucker article 2010 is shown in FIGS. 52 and 53.

The candy sucker article 2010 includes a container 2012 having a lower container portion 2014 and an upper container portion or lid 2016. The lid 2016 is removable from the lower container portion 2014. A rotating device 2060 is removably connected to the lid 2016 of the container 2012, and extends upwardly therefrom. Specifically, the lid 2016 is provided with a sleeve 2016a having an aperture 2016b configured to receive the lower end of the handle 2062 of the rotating device.

The rotating device 2060 includes a rotating spindle 2064 having an aperture 2066 configured to connect with a lollipop 2018. Specifically, the lollipop 2018 includes a hard candy portion 2020 connected on an end of a stick portion 2022. The lower end of the stick portion 2022 is received within the aperture 2066 of the rotating spindle 2064. The rotating device 2060 includes a crank 2068 having a fingergrip 2070. The crank 2068 is configured to rotate the spindle 2064. For example, the crank 2068 can be provided with an internal bevel gear cooperating with another internal bevel gear connected to the spindle 2064. In this manner, when the fingergrip 2070 is rotated as indicated, the spindle 2064 turns the lollipop 2018 as shown. In use, a person removes the lid 2016 from the container 2014 to expose the edible food product 2026 stored therein. The person turns the rotating device 2060 upside down and dips the hard candy portion 2020 of the lollipop 2018 into the container 2014 in contact with the edible food product. The rotating device 2060 is operated to turn the hard candy portion 2020 of the lollipop 2018 to apply the edible food product 2026 to the outer surface of the lollipop after being moisturized by a person licking same.

Another embodiment of the candy sucker article 2110 is shown in FIG. 54.

The candy sucker article 2110 includes a container 2112 having a lower container portion 2114 and an upper container portion or lid 2116. The lid 2116 is removable from the lower container portion 2114 to at least partially fill edible food product 2126 within the container 2112. A rotating device 2160 is connected to an upper portion of the lid 2116.

A hard candy sucker 2120 having a helical groove 2120a provided in an outer surface thereof is disposed within the rotating device 2160. The rotating device 2160 includes a crank 2168 having a fingergrip 2170. The crank 2168 is configured for rotating the candy sucker 2120 within the rotating device 2160. For example, the crank 2168 can be connected to a set of gears and a fictional wheel for engaging an outer surface of the candy sucker 2120 to rotate same within the rotating device 2160. In use, a person rotates the crank 2168 with his or her finger and thumb turning the hard candy sucker 2120 in the direction indicated. The edible food product 2126 stored within the container 2112 is conveyed upwardly within the helical groove 2120a of the candy sucker 2120 until reaching the upper exposed end of the candy sucker 2120, which can then be licked by the person.

Another embodiment of the candy sucker article 2210 according to the present invention is shown in FIG. 55.

The candy sucker article 2210 includes a container 2212 having a lower container portion 2214 and an upper container portion or lid 2216. The lid 2216 is removable from the lower container portion 2214, for example, by a snapfit connection or threaded connection. The lid 2216 is provided with a rotating device 2260. Specifically, the rotating device includes a rotatable fingergrip 2270 configured to spin relative to the lid 2216. A lollipop 2218 including a hard candy portion 2220 and a stick portion 2222 is disposed within the container. An upper end of the stick portion 2222 is connected to the rotatable fingergrip 2270 to allow a person to spin the lollipop when the container 2212 is closed and the lollipop is disposed therein. In use, a person removes the lid 2216 along with the lollipop 2218 from the container 2212. The person then licks the lollipop 2218 and inserts the lollipop into the container 2212 and rotates the lollipop by twisting the fingergrip 2270 with the edible food product 2226 in contact with the outer surface of the hard candy portion 2220 of the lollipop 2218. In this manner, edible food product 2226 is applied to the outer surface of the hard candy 2220 of the lollipop 2218. A person again removes the lollipop from the container 2212 and licks the lollipop 2218 along with the coating of edible food product 2226.

Another embodiment of the candy sucker article 2310 according to the present invention is shown in FIG. 56.

The candy sucker article 2310 includes a container 2312 having a lower container portion 2314 connected to an upper container portion or lid 2316. The lid 2316 is removable from the lower container portion 2314, for example, by a snapfit connection or threaded connection. A lollipop 2318 is disposed within the container 2312. Specifically, the hard candy portion 2320 of the lollipop 2318 is located within the container 2312 and a stick portion 2322 extends through a hole or aperture 2316a of the lid 2316. The candy sucker article 2310 is configured so that the lollipop 2318 can be rotated within the container 2312 by gripping the stick portion 2322 between the thumb and finger and twisting same. In use, a person removes the lid 2316 along with the lollipop 2318 from the container 2312. Then the person licks the outer surface of the hard candy portion 2320 of the lollipop 2318, and then dips the hard candy portion 2320 of the lollipop 2318 into the container 2312 into contact with the edible food product 2326. A person then rotates the lollipop 2318 by twisting the stick portion 2322 applying the edible food product 2326 to an outer surface of the hard candy portion 2320 of the lollipop 2318. A person then removes the lollipop 2318 by removing the lid 2316 from the container 2320 and licks the lollipop with the coated edible food product thereon.

Another embodiment of the candy sucker article 2410 according to the present invention is shown in FIG. 57.

The candy sucker article 2410 includes a container 2412 having a lower container portion 2414 and an upper container portion or lid 2416. The lid 2416 is removable from the lower container portion 2414, for example, by a snapfit connection or threaded connection. The lid 2416 is provided with a rotating device 2460 configured for rotating a candy sucker 2420 within the container 2412. Specifically, the rotating device 2460 includes a fingergrip 2470 configured to connect with the lid 2416 and rotate relative thereof. The fingergrip 2470 includes a downwardly extending protrusion configured to connect with the candy sucker 2420. For example, the candy sucker 2420 can be molded onto the bottom of the fingergrip 2420 so that the protrusion 2470a is embedded within the candy sucker 2420. In use, a person removes the lid 2416 from the container 2412 and licks the outer surface of the candy sucker 2420. The person then dips the candy sucker 2420 into the edible food product 2426 stored within the container 2412, and then rotates the fingergrip 2470 to spin the candy sucker 2420 within the container 2412. The edible food product 2426 is applied to the outer surface of the candy sucker 2420. The person then removes the candy sucker 2420 from the container 2412 and licks the outer surface thereof coated with the edible food product 2426.

Another embodiment of the candy sucker article 2510 according to the present invention is shown in FIG. 58.

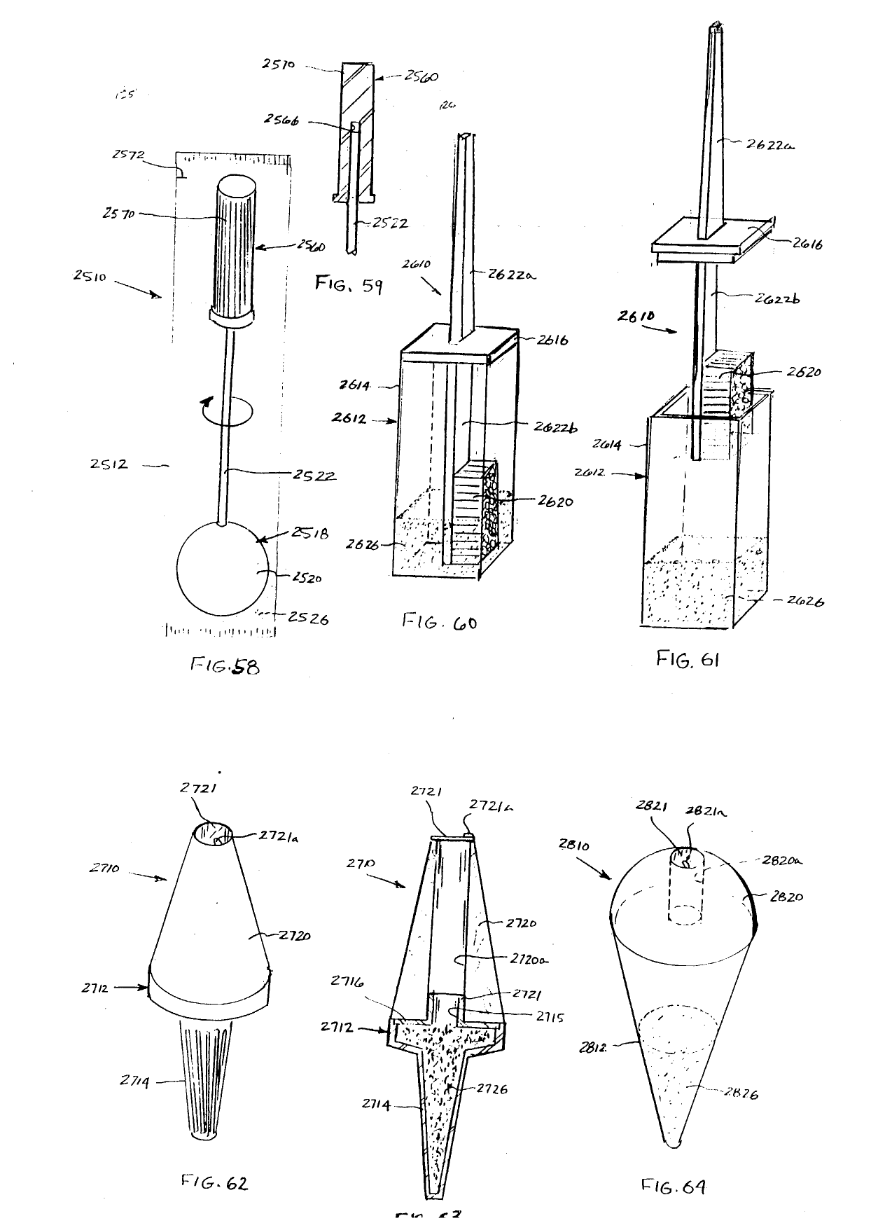

The candy sucker article 2510 includes a container 2512 (e.g. flexible container, bag, plastic bag, wrapper, plastic wrapper, pouch, etc.) containing a lollipop 2518 and edible food product 2526. For example, the container 2512 can be a clear saran wrap material formed in a continuous wrapper material, cut and heat sealed at opposite ends to seal the lollipop 2518 and edible food product 2526. The lollipop includes a hard candy portion 2520 connected to a stick portion 2522. A rotating device 2560 is connected to the free end of the lollipop stick portion 2522. As shown in FIG. 59, the rotating device 2560 can be a plastic injection molded part having an aperature 2566 configured to connect with the free end of the lollipop stick 2522. The rotating device 2560 includes a fingergrip 2570 (e.g. configured to fit between forefinger and thumb), and configured to allow a person to twist the lollipop using the fingergrip 2570. In use, a person opens the container 2512, by tearing at the precut 2572 to allow tearing traversely along the width of the container 2512. The person then removes the lollipop by use of the fingergrip 2570, licks the outer surface of the lollipop, and then dips the lollipop back into the container 2512 into contact with the edible food product 2526 located in the bottom portion thereof. The person then twists the lollipop 2518 by use of the fingergrip 2570 to apply the edible food product 2526 to the outer surface of the hard candy portion 2520 of the lollipop 2518. The person withdraws the lollipop 2518 from the container 2512, and then licks the lollipop with the outer coating of edible food product 2526.

Another embodiment of the candy sucker article 2610 according to the present invention is shown in FIGS. 60 and 61.

The candy sucker article 2610 includes a container 2612 including a lower container portion 2614 and an upper container portion or lid 2616. The candy sucker article 2610 is configured to simulate a toothbrush and holder.

The lid 2616 is provided with an upwardly extending handle portion 2622a and a downwardly extending handle portion 2622b provided with a candy sucker 2620 configured to simulate the bristles of a toothbrush. The lid 2616 removably connects to the lower container portion 2614, for example, by a snapfit connection or interference fit. In use, a person grabs the handle portion 2622a and lifts the lower handle portion 2622b in candy sucker 2620 from within the container 2612. The person then licks the outer surface of the candy sucker 2620, and then dips the candy sucker 2620 into the edible food product 2626 located within the container 2612. The edible food product 2626 is applied to the outer surface of the candy sucker 2620, and then the person withdraws the candy sucker 2620 from the container and licks the candy sucker 2620 provided with the coating of the edible food product 2626.

Another embodiment of the candy sucker article 2710 according to the present invention is shown in FIGS. 62 and 63.

The candy sucker article 2710 includes a container 2712 having a lower container portion 2714 configured to be a handle and an upper container portion or lid 2716. In some embodiments, the lid 2716 is removable, and in other embodiments the lid 2716 is substantially permanently attached or connected to the lower container portion 2714. The lid 2716 is provided with a protrusion 2721 having a through hole 2715 therein. A candy sucker 2720 is connected or formed (e.g. molded) on top of the lid 2716 as shown. The candy sucker 2720 is provided with a through passageway 2720a contiguous with the through hole 2715 in the lid 2716. A removable seal 2721 having a pull tab 2721a is provided at the top of the candy sucker 2720 to protect and seal the through passageway 2720a. In use, a person removes the seal 2721 by pulling on the pull tab 2721a. The person places their mouth over the upper end of the candy sucker 2720 and turns the candy sucker article 2710 upside down allowing the edible food product 2726 to flow through the through hole 2715 in the lid 2716 in the through passageway 2720a through the candy sucker 2720 to the person's mouth. After receiving a dose of the edible food product 2726, the person then turns the candy sucker article 2710 back upright in order to stop dispensing the edible food product 2726 therefrom. The person then can continue to lick the candy sucker 2720.

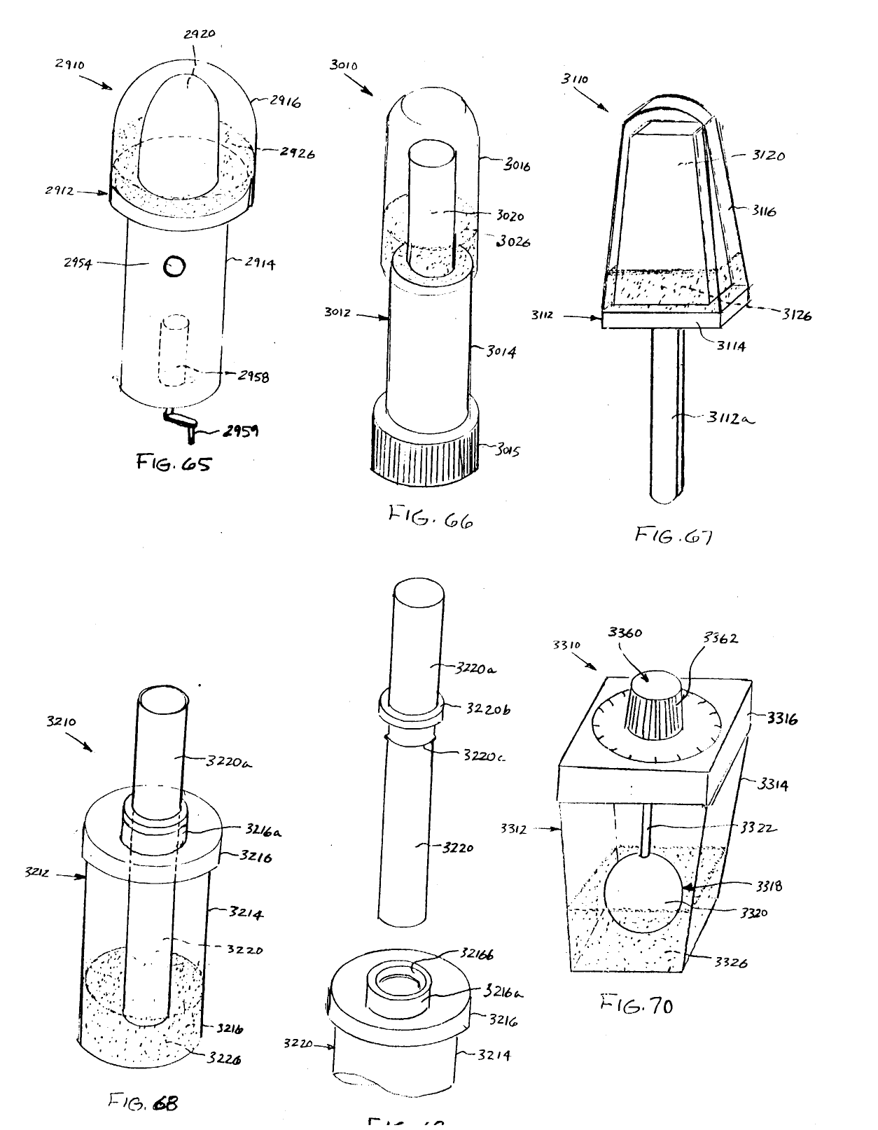

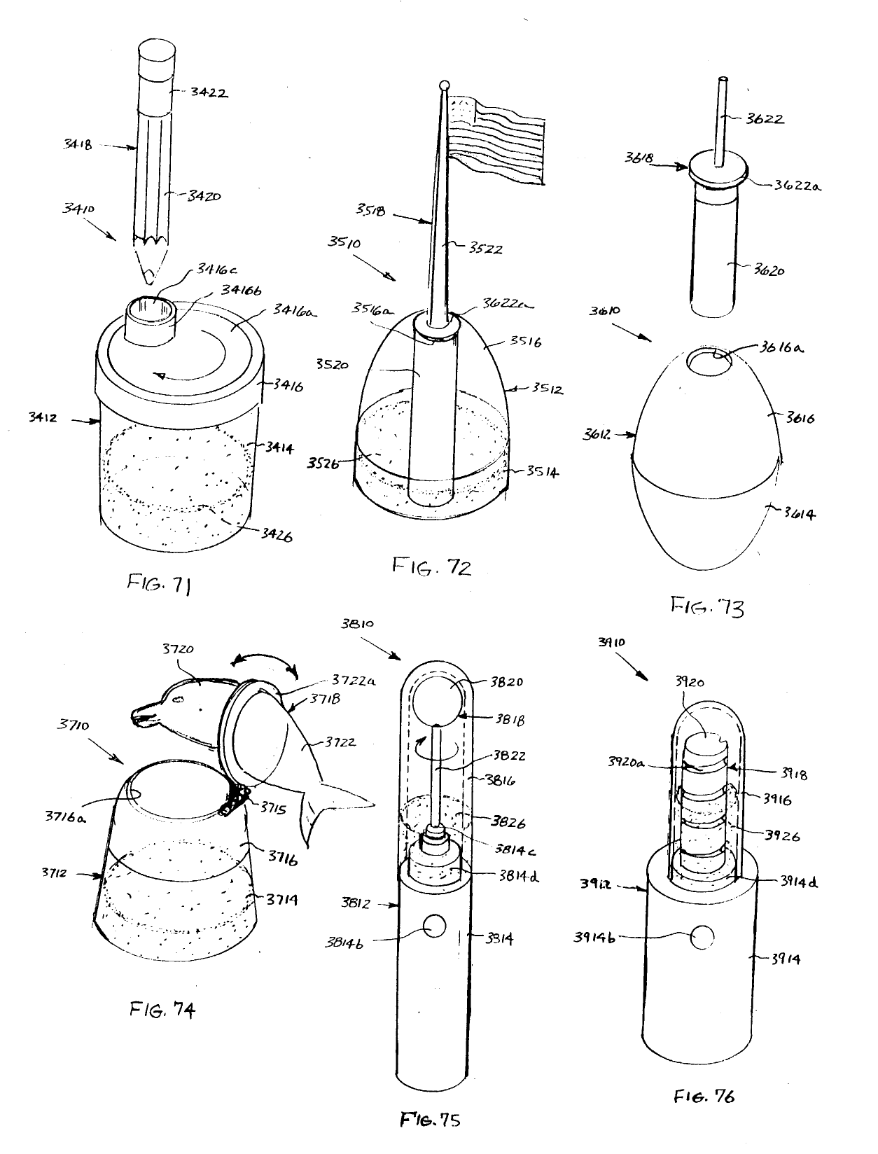

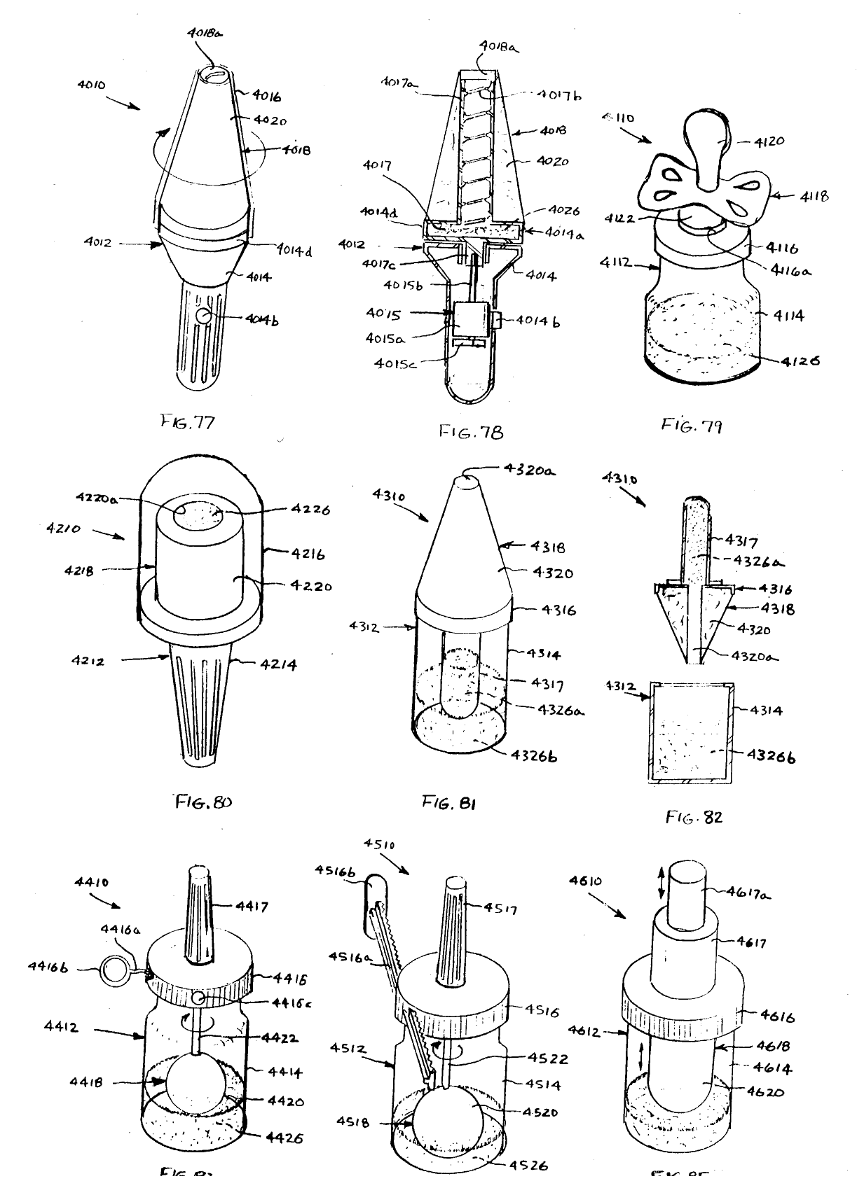

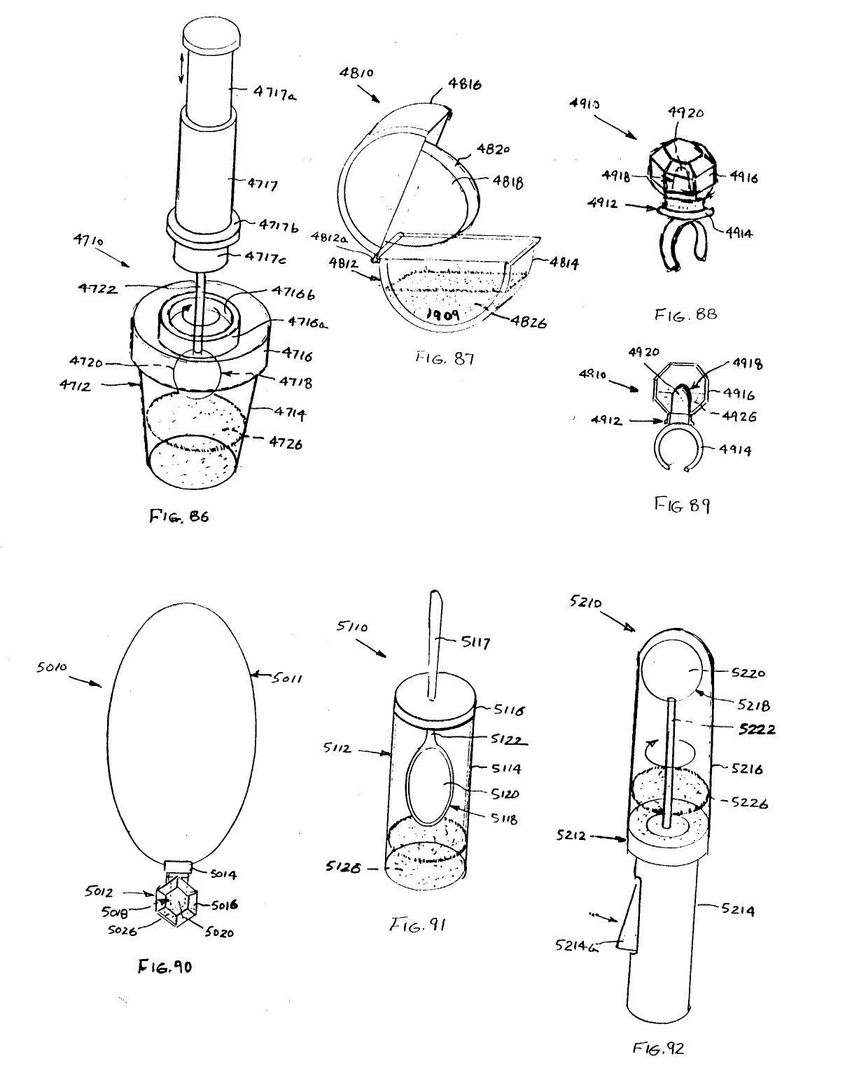

Another embodiment of the candy sucker article 2810 according to the present invention is shown in FIG. 64.

The candy sucker article 2810 includes a container 2812 and a candy sucker 2820 connected together. The candy sucker article 2810 is configured to simulate a sno-cone. The candy sucker 2820 is provided with a through passageway 2820a. A seal 2821 having a pull tab 2821a is provided at an upper end of the candy sucker 2820 to seal the through passageway 2820a. In use, a person removes the seal 2821 by pulling the pull tab 2821a. The person places the upper end of the candy sucker 2820 in his or her mouth, and then turns the candy sucker article 2810 upside down. The edible food product 2826 begins to pour through the through passageway 2820a of the candy sucker 2820 into the person's mouth. After the person has received a dose of the edible food product 2826 in his or her mouth, the person then turns the candy sucker article 2810 right side up, and then could lick the outer surface of the candy sucker 2820.

Another candy sucker article device 2910 according to the present invention is shown in FIG. 65.

The candy sucker article 2910 includes a container 2912 having a lower container portion 2914 configured to be a handle, and an upper housing portion or lid 2916 to be configured as a dome, preferably a see-through dome. The lower container portion 2914 includes a manually operated spring wind up mechanical vibrator 2958 and a push button switch 2954 configured to actuate the mechanical vibrator 2958 configured to mechanically vibrate the candy sucker article 2910. The vibrator 2958 can be wound up by crank 2959. A candy sucker 2920 is connected to the lower container portion 2914 and extends upwardly within the dome-shaped lid 2916. An edible food product 2926 is stored within the upper container portion or lid 2916. In use, a person turns the candy sucker article 2910 upside down and separates the lower container portion 2914 from the upper container portion 2916 so that the edible food product 2926 remains within the upside down dome-shaped lid 2916. The person then licks the outer surface of the candy sucker 2920, and then dips the candy sucker 2920 into the lid 2916 into contact with the edible food product 2926 contained therein. The edible food product is applied to the outer surface of the candy sucker. Alternatively, after licking the person can connect the lower container portion 2914 to the upper container portion 2916 both turned upside down, and press the push button switch 2954 to cause the candy sucker article 2910 to vibrate causing the edible food product 2926 to be applied to the outer surface of the candy sucker 2920. In some cases, the lower container portion 2914 and upper container portion 2916 are separated, and then the candy sucker 2920 is placed into contact with the edible food product 2926 contained within the upper container portion 2916 turned upside down. The push button switch 2954 is activated to vibrate the candy sucker 2920 in contact with the edible food product 2926 applying same thereon.

Another embodiment of the candy sucker article 3010 according to the present invention is shown in FIG. 66.

The candy sucker article 3010 includes a container 3012 having a lower container portion 3014 connected to an upper container portion 3016. Preferably, the upper dome-shaped container 3016 is see-through, and removable from the lower container portion 3014. The lower container portion 3014 includes a rotatable fingergrip 3015 configured to extend or retract the candy sucker 3020 from or into the lower container portion 3012. For example, the rotatable fingergrip 3015 can include a threaded protrusion extending upwardly cooperating with a threaded sleeve coupled to the lower end of the candy sucker 3020. Otherwise a manually operated mechanism similar to a compact lipstick can be utilized for driving the candy sucker 3020 upwardly and downwardly. In use, a person turns the candy sucker article 3010 upside down and separates the lower container portion 3014 from the upper container portion 3016 containing edible food product 3026. The person licks the outer surface of the candy sucker 3020, and then dips the candy sucker 3020 into the edible food product 3026 contained in the upper container portion 3016. The fingergrip 3015 can be rotated to further extend the candy sucker 3020 relative to the lower container portion 3012 to facilitate dipping the end of the candy sucker 3020 into the upside down upper container portion 3016 to apply edible food product to the outer surface thereof.

Another embodiment of the candy sucker article 3110 according to the present invention is shown in FIG. 67. The candy sucker article 3110 includes a container 3112 having a lower container portion 3114 connected to an upper container portion 3116. The lower container portion 3112 includes a handle portion 3112a extending downwardly therefrom. The candy sucker article 3110 is configured to simulate a popsicle type ice cream product.

A candy sucker 3120 is connected to the lower container portion 3112 and extends upwardly therefrom within the upper container portion 3116. Preferably, the upper container portion 3116 is clear or transparent to allow a person to visualize the candy sucker 3120 and the edible food product 3126. In use, a person turns the candy sucker article 3110 upside down, and separates the lower container portion 3114 from the upper container portion 3116 now containing the edible food product 3126. The person then licks the outer surface of the candy sucker 3120 and dips the candy sucker 3120 into the upside down upper container portion 3116 into contact with the edible food product 3126. The edible food product 3126 is then applied to the outer surface of the candy sucker 3120.

Another embodiment of the candy sucker article 3210 according to the present invention is shown in FIGS. 68 and 69.

The candy sucker article 3210 includes a container 3212 having a lower container portion 3214 connected to an upper container portion 3216. The upper container portion 3216 can be removable from the lower container portion 3214, for example, by providing a snapfit connection or threaded connection. Alternatively, the upper container portion 3216 is substantially permanently connected to the lower container portion 3214. The upper container portion includes a sleeve 3216a having a through hole 3216b configured for receiving a sucker 3220 connected to a handle portion 3220a. The handle 3220a includes a stop 3220b and a ridge 3220c to provide a snap connection with the lid 3216. This embodiment allows for the quick connect and disconnect between the candy sucker and container 3212 to minimize the amount of effort needed to open the container 3212 and to provide convenience and use.

In use, a person grabs the handle 3220a and pulls upwardly to remove the candy sucker 3220 from the container 3212. A person licks the outer surface of the candy sucker 3220, and inserts the end through the through hole 3216b of the lid 3216. The person shakes the candy sucker article 3210 to apply edible food product 3226 to the outer surface of the candy sucker 3220.

Another candy sucker article 3310 according to the present invention is shown in FIG. 70.

The candy sucker article 3310 includes a container 3312 having a lower container portion 3314 connected to an upper container portion or lid 3316. The candy sucker article 3310 is configured to simulate a lock or safe.

A rotating device 3360 having a fingergrip 3362 is provided on the lid 3316. A lollipop 3318 is disposed within the container 3312. The lollipop includes a hard candy portion 3320 connected to a stick portion 3322. The stick portion 3322 is connected to the rotating device 3360. For example, the fingergrip 3362 can be provided with a hole or aperture on the bottom thereof configured to receive the free end of the lollipop stick 3322. In use, a person removes the lid 3316 from the lower container portion 3314 and then licks the outer surface of the lollipop. The person then dips the lollipop back into the lower container portion 3314 and twists the fingergrip 3360 with the lollipop in contact with the edible food product 3326 to apply same to the outer surface of the lollipop.

Another embodiment of the candy sucker article 3410 according to the present invention is shown in FIG. 71.

The candy sucker article 3410 includes a container 3412 having a lower container portion 3414 connected to an upper container portion or lid 3416. The lid 3416 can be substantially permanently attached to the lower container portion 3414, or can be removably attached, for example, by providing a threaded connection or snapfit connection therebetween.

The candy sucker article 3410 is configured to simulate a pencil sharpener. The lid 3416 includes a rotatable lid portion 3416a provided with an upwardly extending sleeve 3416b having a through hole 3416c therein.

A lollipop 3418 configured to simulate a pencil is configured to fit through the through hole 3416c of the rotatable lid portion 3416a. The lollipop 3418 includes a hard candy portion 3420 and a stick portion 3422. In use, the user licks the hard candy portion 3420 of the lollipop 3418, and then dips the lower end of the lollipop 3418 through the through hole 3416c of the rotatable lid portion 3416a until the tip of the lollipop 3418 comes into contact with the edible food product 3426 stored in the container 3416 to apply a coating thereof onto the hard candy portion 3420 of the lollipop 3418. The lollipop 3418 can be manipulated by the user so that the lollipop 3418 spins within the container 3412 the same or similar to a pencil sharpener. The user then withdraws the lollipop 3418 and then licks the hard candy portion 3420 of the lollipop 3418.

Another embodiment of the candy sucker article 3510 according to the present invention is shown in FIG. 72.

The candy sucker article 3510 includes a container portion 3512 having a lower container portion 3514 and an upper container portion or lid 3516. The upper container portion 3516 can be removably connected to the lower container portion 3514. A lollipop 3518 having a hard candy portion 3520 and a stick portion 3522 is removably connected to the lid 3516. For example, the stick portion 3522 is provided with a flange 3522a configured to snap fit into a through hole 3516a of the lid 3516. The lid 3516, for example, can be made of a see through plastic material (e.g. clear and colorless, clear and colored, clear and tinted, transparent and translucent) to allow viewing of the hard candy portion 3520 and edible food product 3526 stored within the container portion 3512. Optionally, the lower container portion 3514 can also be made of see through plastic material. Further, the lid 3516 is shown dome-shaped, however, other shapes can be substituted therefore.

In use, a person grips the stick portion 3522 of the lollipop 3518 while gripping the container portion 3512, and pulls the lollipop 3518 from the container portion 3512. The person licks the outer surface of the hard candy portion 3520, and then reinserts the hard candy portion 3520 of the lollipop back into the container portion 3512 so that said hard candy portion 3520 makes contact with the edible food product 3526. The person may twist the lollipop 3518 relative to the container portion 3512 so that the edible food product 3526 is applied to an outer surface of the hard candy portion 3520 of the lollipop 3518. The person again removes the lollipop 3518 from the container portion 3512 to allow the person to lick the edible food product 3526 and hard candy portion 3520 of the lollipop 3518.

Another embodiment of the candy sucker article 3610 according to the present invention is shown in FIG. 73.

The candy sucker article 3610 includes a container portion 3612 having a lower container portion 3614 and an upper container portion or lid 3616. The upper container portion 3616 can be removably connected to the lower container portion 3614. A lollipop 3618 having a hard candy portion 3620 and a stick portion 3622 is removably connected to the lid 3616. For example, the stick portion 3622 is provided with a flange 3622a configured to snap fit into a through hole 3616a of the lid 3616. The lid 3616, for example, can be made of a see through plastic material (e.g. clear and colorless, clear and colored, clear and tinted, transparent and translucent) to allow viewing of the hard candy portion 3620 and edible food product 3626 stored within the container portion 3612. Optionally, the lower container portion 3614 can also be made of see through plastic material. Further, the container portion 3614 is shown as egg-shaped, however, other shapes can be substituted therefore.

In use, a person grips the stick portion 3622 of the lollipop 3618 while gripping the container portion 3612, and pulls the lollipop 3618 from the container portion 3612. The person licks the outer surface of the hard candy portion 3620, and then reinserts the hard candy portion 3620 of the lollipop back into the container portion 3612 so that said hard candy portion 3620 makes contact with the edible food product 3626. The person may twist the lollipop 3618 relative to the container portion 3612 so that the edible food product 3626 is applied to an outer surface of the hard candy portion 3620 of the lollipop 3618. The person again removes the lollipop 3618 from the container portion 3612 to allow the person to lick the edible food product 3626 and hard candy portion 3620 of the lollipop 3618.

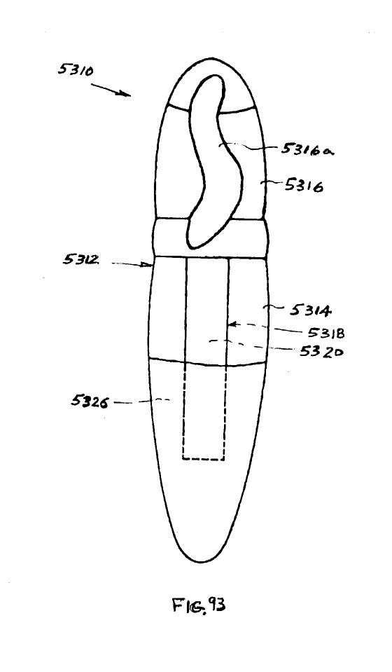

Another embodiment of the candy sucker article 3710 according to the present invention is shown in FIG. 74.

The candy sucker article 3710 includes a container portion 3712 having a lower container portion 3714 and an upper container portion or lid 3716. The upper container portion 3716 can be removably connected to the lower container portion 3714. A lollipop 3718 having a hard candy portion 3720 and a stick portion 3722 is removably connected to the lid 3716. For example, the stick portion 3722 is provided with a flange 3722a configured to snap fit into a through hole 3716a of the lid 3716. The lid 3716, for example, can be made of a see through plastic material (e.g. clear and colorless, clear and colored, clear and tinted, transparent and translucent) to allow viewing of the hard candy portion 3720 and edible food product 3726 stored within the container portion 3712. Optionally, the lower container portion 3714 can also be made of see through plastic material. Further, the container portion 3712 is shown as a truncated cone-shaped container, however, other shapes can be substituted therefore. In this embodiment, the lollipop 3718 is shaped in the figure of an animal (e.g. porpoise or bottle nose dolphin) diving into a diving tank simulated by the shape of the container portion 3712.

The lollipop 3718 is connected to the container portion 3712 by a hinge 3715. The hinge 3715 can be a multiple component type hinge as shown (e.g. two mating pieces connected together by pin), or a live hinge can be substituted therefore (e.g. a live hinge formed by a plastic injection molding technique). In this embodiment, the hinge defines the movement of the lollipop 3718 relative to the container portion 3712 so as to simulate the porpoise or dolphin diving into the simulated diving tank.

In use, a person grips the stick portion 3722 of the lollipop 3718 while gripping the container portion 3712, and hinges the lollipop 3718 out from the container portion 3712. The person licks the outer surface of the hard candy portion 3720, and then reinserts the hard candy portion 3720 of the lollipop back into the container portion 3712 so that said hard candy portion 3720 makes contact with the edible food product 3726. The person may twist the lollipop 3718 relative to the container portion 3712 so that the edible food product 3726 is applied to an outer surface of the hard candy portion 3720 of the lollipop 3718. The person again removes the lollipop 3718 from the container portion 3712 to allow the person to lick the edible food product 3726 and hard candy portion 3720 of the lollipop 3718.

Another embodiment of the candy sucker article 3810 according to the present invention is shown in FIG. 75.

The candy sucker article 3810 includes a container portion 3812 having a lower container portion 3814 and an upper container portion or lid 3816. The upper container portion 3816 can be removably connected to the lower container portion 3814. The lower container portion 3814 is provided with a manually operated spring wind up mechanism configured to selectively drive a spindle 3814a of the lower container portion 3814 upon actuation of button 3814b. The spring mechanism is the same or similar to the spring mechanism shown and described for the embodiment shown in FIG. 78. A lollipop 3818 having a hard candy portion 3820 and a stick portion 3822 is connected to the rotating spindle 3814a of the lower container portion 3814. The lollipop 3818 and spindle 3814a can be configured to allow the lollipop 3818 to be removed from the spindle 3814a and then replaced. For example, the lower end of the stick portion 3822 is received within an aperture 3814c of the spindle 3814a for securely and removably connecting the lollipop 3818 to the spindle 3814a. A lower end of the lid 3816 is configured to connect to an upper end of the lower container portion 3814. For example, an inner surface of the lower end of the lid 3816 snap fits or interference fits with a flange 3814d of the lower container portion 3814. The removable lid 3816, for example, can be made of a see through plastic material (e.g. clear and colorless, clear and colored, clear and tinted, transparent and translucent) to allow viewing of the hard candy portion 3820 and edible food product 3826 stored within the container portion 3812. Optionally, the lower container portion 3814 can also be made of see through plastic material to allow a person to view the spring wind up mechanism.

In use, a person turns the candy sucker article 3810 upside down so that the edible food product 3826 is retained within the lid 3816, and then removes the lid 3816 from the lower container portion 3814. The person licks the outer surface of the hard candy portion 3820, and then reattaches the lid 3816 to the lower container portion 3814. The person then presses the button 3814b to cause the lollipop 3818 to spin within the lid 3816 to apply the edible food product 3826 to the outer surface of the hard candy portion 3820. The person then again removes the lid 3816 with the candy sucker article turned upside down, and places the lollipop 3818 in his or her mouth while pressing the button 3814b to cause the lollipop to rotate therein. Prior to use, the spring mechanism is wound up by reverse rotating the lollipop 3818 by hand readied to be actuated by push button 3814b.

Another embodiment of the candy sucker article 3910 according to the present invention is shown in FIG. 76.

The candy sucker article 3910 includes a container portion 3912 having a lower container portion 3914 and an upper container portion or lid 3916. The upper container portion 3916 can be removably connected to the lower container portion 3914. The lower container portion 3914 is provided with a manually operated spring wind up mechanism configured to selectively drive the lollipop 3918 of the lower container portion 3914 upon actuation of button 3914b. The spring mechanism is the same or similar to the spring mechanism shown and described for the embodiment shown in FIG. 78. A lollipop 3918 having a hard candy portion 3920 is connected to a rotating spindle located within the lower container portion 3914. The lollipop 3918 and internal spindle can be configured to allow the lollipop 3918 to be removed from the internal spindle and then replaced. For example, the lower end of the hard candy portion 3920 is received within an aperture of the internal spindle for securely and removably connecting the lollipop 3918 to the interior spindle. The hard candy portion 3920 is provided with a helical groove 3920a the same as or similar to a drill.

A lower end of the lid 3916 is configured to be connected to an upper end of the lower container portion 3914. For example, an inner surface of the lower end of the lid 3916 snap fits or interference fits with a flange 3914d of the lower container portion 3914. The removable lid 3916, for example, can be made of a see through plastic material (e.g. clear and colorless, clear and colored, clear and tinted, transparent and translucent) to allow viewing of the hard candy portion 3920 and edible food product 3926 stored within the container portion 3912. Optionally, the lower container portion 3914 can also be made of see through plastic material to allow a person to view the spring wind up mechanism.

In use, a person turns the candy sucker article 3910 upside down so that the edible food product 3926 is retained within the lid 3916, and then removes the lid 3916 from the lower container portion 3914. The person licks the outer surface of the hard candy portion 3920, and then reattaches the lid 3916 to the lower container portion 3914. The person then presses the button 3914b to cause the lollipop 3918 to spin within the lid 3916 to apply the edible food product 3926 to the outer surface of the hard candy portion 3920. The person then again removes the lid 3916 with the candy sucker article turned upside down, and places the lollipop 3918 in his or her mouth while pressing the button 3914b to cause the lollipop to rotate therein. Prior to use, the spring mechanism is wound up by reverse rotating the lollipop 3918 by hand readied to be actuated by push button 3914b.

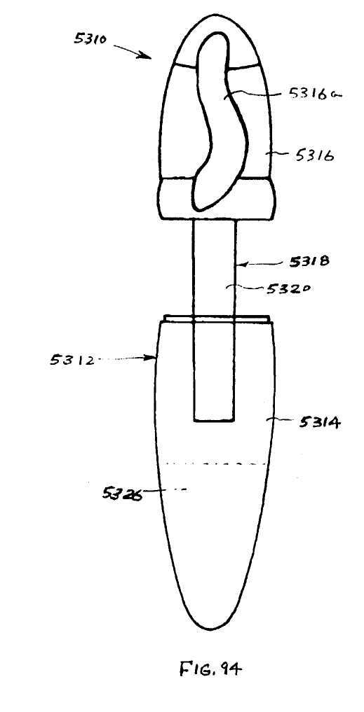

Another embodiment of the candy sucker article 4010 according to the present invention is shown in FIGS. 77 and 78.

The candy sucker article 4010 includes a container portion 4012 having a lower container portion 4014 and an upper container portion or lid 4016. The upper container portion 4016 can be removably connected to the lower container portion 4014. The lower container portion 4014 is provided with a manually operated wind up spring mechanism 4015 configured to selectively drive a spindle 4014a of the lower container portion 4014 upon actuation of button 4014b. Specifically, the spring mechanism includes a housing 4015a provided with bearings for rotatably supporting shaft 4015b connected to spindle 4014a. Further, the housing is provided with a locking mechanism (e.g. escapement, latch or ratchet)configured to prevent rotation of the shaft 4015b in one direction (i.e. “driving” direction) while allowing substantially free rotation in an opposite direction. A helical spring 4015c is connected between the housing 4015a and shaft 4015b to apply a “driving” force to shaft 4015b when the helical spring 4015c is wound up. The button 4014b is configured to selectively release or trip the locking mechanism to allow the shaft 4015b to be driven by the helical spring 4015c, and in turn rotate the spindle 4014a and lollipop 4018. The lollipop 4018 includes a hard candy portion 4020 connected to the rotating spindle 4014a of the lower container portion 4014. For example, the hard candy portion 4020 is molded onto a plastic injection mold spindle 4014a.

The rotatable spindle 4014a is configured to define a reservoir 4017 for storing edible food product 4026. The rotatable spindle 4014a is provided with an upwardly extending hollow shaft 4017a provided with a helical-shaped protrusion 4017b configured to function the same as or like an auger. For example, the rotatable spindle 4014a can be a single piece plastic injection mold part. The rotatable spindle 4014a is provided with a downwardly extending flange 4017c configured for connection with shaft 4015b of the manually operated wind up spring mechanism 4015. For example, the end of the shaft 4015b is keyed to fit within a keyed aperture molded in the lower end of the flange 4017c.

A lower end of the lid 4016 is configured to be connected to an upper end of the lower container portion 4014. For example, an inner surface of the lower end of the lid 4016 snap fits or interference fits with a flange 4014d of the lower container portion 4014. The removable lid 4016, for example, can be made of a see through plastic material (e.g. clear and colorless, clear and colored, clear and tinted, transparent and translucent) to allow viewing of the hard candy portion 4020 and edible food product 4026 stored within the container portion 4012. Optionally, the lower container portion 4014 can also be made of see through plastic material to allow a person to view the spring wind up mechanism.

In use, a person removes the lid 4016, and turns the candy sucker article 4010 on its side and places the exit portion 4018a of the lollipop in his or her mouth. The person then presses the button 4014b to drive the spindle 4014a and rotate the lollipop 4018. The edible food product 4026 stored within the reservoir 4017 of the spindle 4014a is transferred from the reservoir by the auger arrangement in hollow shaft 4017b to the exit port 4018a of the lollipop 4018, and then into the person's mouth. Prior to use, the helical spring 4015c is wound up by reverse rotating the lollipop 4018 by hand readied to be actuated by push button 4014b.

Another embodiment of the candy sucker article 4110 according to the present invention is shown in FIG. 79.

The candy sucker article 4110 includes a container portion 4112 having a lower container portion 4114 and an upper container portion or lid 4116. The upper container portion 4116 can be removably connected to the lower container portion 4114. A lollipop 4118 having a hard candy portion 4120 and grip portion 4122 is configured to simulate a baby pacifier, and is removably connected to the lid 4116. For example, the grip portion 4122 is configured to snap fit into a through hole 4116a of the lid 4116. Alternatively, the lollipop 4118 is connected directly to the lid 4116, and can be separated from the lower container portion 4114 as a unit with the lid 4116. The container portion 4112, for example, can be made of a see through plastic material (e.g. clear and colorless, clear and colored, clear and tinted, transparent and translucent) to allow viewing of the edible food product 4126 stored within the container portion 4112.

In use, a person grips the grip portion 4122 of the lollipop 4118 while gripping the container portion 4112, and pulls the lollipop 4118 from the container portion 4112 and lid 4116. The person licks the outer surface of the hard candy portion 4120, and then reinserts the hard candy portion 4120 of the lollipop back into the container portion 4112 so that the hard candy portion 4120 makes contact with the edible food product 4126. The person may twist the lollipop 4118 relative to the container portion 4112 so that the edible food product 4126 is applied to an outer surface of the hard candy portion 4120 of the lollipop 4118. The person again removes the lollipop 4118 from the container portion 4112 to allow the person to lick the edible food product 4126 and hard candy portion 4120 of the lollipop 4118.

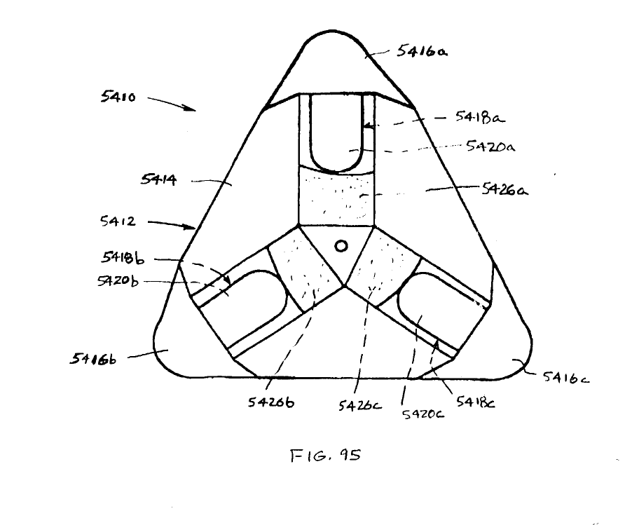

Another embodiment of the candy sucker article 4210 according to the present invention is shown in FIG. 80.

The candy sucker article 4210 includes a container portion 4212 having a lower container portion 4214 and an upper container portion or lid 4216. The upper container portion or lid 4216 is removably connected to the lower container portion 4214. A lollipop 4218 having a hard candy portion 4220 is connected to the lower container portion 4214. The lid 4216, for example, can be made of a see through plastic material (e.g. clear and colorless, clear and colored, clear and tinted, transparent and translucent) to allow viewing of the edible food product 4226 stored within a hollow center portion of the hard candy portion 4220 and/or stored within the lower container portion 4214. For example, the edible food product 4226 can be loosely filled into the hollow center portion 4220a of the hard candy portion 4220 and the lower container portion 4214. Alternatively, the edible food product 4226 can be tightly filled or compacted into the hollow center portion 4220a of the hard candy portion 4220. Optionally, the lower container portion 4214 can also be made of see through plastic material to allow view of edible food product stored therein.

In use, a person grips the lower container portion 4214 and removes the upper container portion 4216 therefrom. The person licks the outer surface of the hard candy portion 4220, and then turns the lower container portion 4214 upside down to allow edible food product 4226 to pour out of the hollow center portion 4220a of the hard candy portion 4220 and lower container portion 4214. In embodiments wherein the edible food product 4226 is tightly filled or compacted within the hollow center portion 4220a of the hard candy portion 4220, the person licks both the hard candy portion 4220 and edible food product 4226 simultaneously at a top end portion of the hard candy portion 4220.

Another embodiment of the candy sucker article 4310 according to the present invention is shown in FIGS. 81 and 82.

The candy sucker article 4310 includes a container portion 4312 having a lower container portion 4314 and an upper container portion or lid 4316. The upper container portion or lid 4316 is removably connected to the lower container portion 4314. The upper container portion 4316 is provided with a handle portion 4317 disposed within the lower container portion 4314. A lollipop 4318 having a hard candy portion 4320 is connected to the upper surface of the upper container portion 4316. The lid 4316, for example, can be made of a see through plastic material (e.g. clear and colorless, clear and colored, clear and tinted, transparent and translucent) to allow viewing of the edible food product 4326a stored within the handle portion 4317 of the upper container portion 4316. For example, the edible food product 4326a can be loosely filled into the handle portion 4317. Optionally, the lower container portion 4314 can also be made of see through plastic material to allow viewing of the edible food product 4326b stored therein.

The hard candy portion 4320 is provided with a hollow center or through passageway 4320a communicating with the interior of the lower container portion 4314 containing edible food product 4326a. Further, the lower container portion 4314 can stored a quantity of edible food product 4326b. The edible food product 4326a and 4326b can be the same or different edible food products (e.g. different flavors, different types, different colors, different shapes, different sizes).

In use, a person grips the lower container portion 4314 and removes the upper container portion 4316 therefrom. The person licks the outer surface of the hard candy portion 4320, and then turns the upper container portion 4314 upside down to allow edible food product 4326a to pour through and out of the hollow center portion or through passageway 4320a of the hard candy portion 4320. Further, the hard candy portion 4316 can be dipped into the edible food product 4326b stored within the open lower container portion 4314. The edible food product 4326a stored in the upper container portion 4316 can be mixed with the edible food product 4326b stored in the lower container portion 4314 by pouring, as shown in FIG. 82.

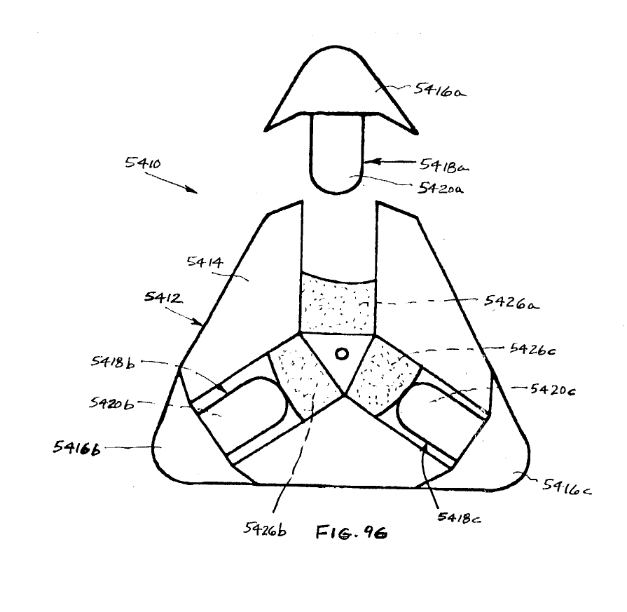

Another embodiment of the candy sucker article 4410 according to the present invention is shown in FIG. 83.

The candy sucker article 4410 includes a container 4412 having a lower container portion 4414 connected to an upper container portion or lid 4416. The upper container portion 4416 is removably connected to the lower container portion 4414, for example, by providing a snapfit connection, twist or threaded connection therebetween. The upper container portion 4416 is provided with a handle portion 4417. A lollipop 4418 having a hard candy portion 4420 connected to a stick portion 4422 extends downwardly from the upper lid portion 4416.

The upper container portion 4416 is configured to twist or turn the lollipop 4418 both when disposed within the lower container portion 4414, and when removed from the lower container portion 4414. For example, the upper container portion 4416 is provided with a pull thread or string 4416a having a finger grip 4416b located at an end thereof. Preferably the upper container portion 4416 is spring loaded (e.g. with a spiral or helix shaped spring) configured so that when the pull string 4416a is pulled out, the pull string 4416a will retract automatically. In one embodiment, the lollipop 4418 does not rotate when the pull string 4416a is retracted, and in another embodiment the lollipop 4418 spins when the pull string is retracted (e.g. spins clockwise or counter-clockwise). In addition, the upper container portion 4416 can be configured to spin or not spin the lollipop when the pull string is being pulled out. In an alternative embodiment, the pull string is couple with a mechanism located within the upper lid portion 4416 that can wind up and spin the lollipop 4418 faster and faster with each pull (e.g. ratchet mechanism in combination with gyro). As another alternative, the pull string is coupled with a mechanism configured to wind up, and then be released upon disengaging a locking device, for example, by pressing a button 4416c configured to selectively spin the lollipop 4418.

In use, a person grabs the handle portion 4417 and pulls upwardly or twists same to remove the lollipop 4418 from the lower container portion 4414. A person licks the outer surface of the lollipop 4418, and inserts the lollipop 4418 into the lower container portion 4414. The person pulls out the pull string 4416a to spin the lollipop 4418 to apply edible food product 4426 stored within the lower container portion 4414 onto the outer surface of the lollipop 4418.

Another embodiment of the candy sucker article 4510 according to the present invention is shown in FIG. 84.

The candy sucker article 4510 includes a container 4512 having a lower container portion 4514 connected to an upper container portion or lid 4516. The upper container portion 4516 is removably connected to the lower container portion 4514, for example, by providing a snapfit connection, twist or threaded connection therebetween. The upper container portion 4516 is provided with a handle portion 4517. A lollipop 4518 having a hard candy portion 4520 connected to a stick portion 4522 extends downwardly from the upper lid portion 4516.

The upper container portion 4516 is configured to turn the lollipop 4518 both when disposed within the lower container portion 4514, and when removed from the lower container portion 4514. For example, the upper container portion 4516 is provided with a pull strip 4516a having a finger grip 4516b located at an end thereof. Preferably the upper container portion 4516 is provided with a gyro configured to rotate when the pull strip 4516a is pulled out of the upper lid portion 4516.

In use, a person grabs the handle portion 4517 and pulls upwardly or twists same to remove the lollipop 4518 from the lower container portion 4514. A person licks the outer surface of the lollipop 4518, pulls the pull strip 4516a to begin spinning the gyro and lollipop 4518, and then reinserts the lollipop 4518 into the lower container portion 4514 to apply the edible food product 4526 onto an outer surface of the lollipop 4518. The person then again removes the lollipop 4518 from the lower container portion 4514 while the gyro and lollipop 4518 are still spinning and places the lollipop 4518 in his or her mouth.

Another embodiment of the candy sucker article 4610 according to the present invention is shown in FIG. 85.

The candy sucker article 4610 includes a container 4612 having a lower container portion 4614 connected to an upper container portion or lid 4616. The upper container portion 4616 is removably connected to the lower container portion 4614, for example, by providing a snapfit connection, twist or threaded connection therebetween. The upper container portion 4616 is provided with a handle portion 4617. A lollipop 4618 having a hard candy portion 4620 extends downwardly from the upper lid portion 4616.

The upper container portion 4616 is configured to move the lollipop 4618 upwardly and downwardly both when disposed within the lower container portion 4614, and when removed from the lower container portion 4614. For example, the upper container portion 4616 is provided with a spring loaded push button 4617a extending from the handle portion 4617. Preferably the upper container portion 4616 is configured so that the lollipop 4618 moves downwardly when the button 4617b is depressed, and the lollipop 4618 moves upwardly when the spring loaded button 4617a is released.

Another embodiment of the candy sucker article 4710 according to the present invention is shown in FIG. 86.

The candy sucker article 4710 includes a container 4712 having a lower container portion 4714 connected to an upper container portion or lid 4716. The upper container portion 4716 is removably connected to the lower container portion 4714, for example, by providing a snapfit connection, twist or threaded connection therebetween. The upper container portion 4716 is provided with a handle portion 4717. A lollipop 4718 having a hard candy portion 4720 connected to an end of a stick portion 4722 extends downwardly from the handle portion 4717.

The handle portion 4717 is configured to rotate or twist the lollipop 4718 both when disposed within the lower container portion 4714, and when removed from the lower container portion 4714. For example, the upper container portion 4716 is provided with a spring loaded push button 4717a extending from the handle portion 4717. Preferably the handle portion 4717 is configured so that the lollipop 4718 rotates or twists when the button 4717a is depressed, and the lollipop 4718 further rotates or twists when the spring loaded button 4717a is released and automatically moves upwardly.

The upper lid portion 4716 is provided with an upwardly extending flange 4716a having a passageway 4716b extending therethrough. Further, the handle portion 4717 is provided with an outwardly extending radial flange 4717b and bottom end portion 4717c configured to releasably connect (e.g. snap fit connection or twist connection) with the flange 4716a and passageway 4716b of the upper lid portion 4716. This arrangement provides for a quick connect/disconnect coupling between the handle portion 4717 and the lower container portion 4714.

In use, a person grabs the handle portion 4717 and pulls upwardly or twists same to remove the lollipop 4718 from the lower container portion 4714. A person licks the outer surface of the lollipop 4718, and then reinserts the lollipop 4718 into the lower container portion 4714. The person depresses the push button 4717a to rotate or twist the lollipop 4718 when in contact with the edible food product 4726 to apply the edible food product 4726 onto an outer surface of the lollipop 4718. This step can be repeated a number of times. The person then again removes the lollipop 4718 from the lower container portion 4714 and places the lollipop 4718 in his or her mouth.

Another embodiment of the candy sucker article 4810 according to the present invention is shown in FIG. 87.

The candy sucker article 4810 includes a container 4812 having a lower container portion 4814 connected to an upper container portion or lid 4816. The container 4812 can be configured to simulate a coin or medal. The upper container portion 4816 is pivotably connected to the lower container portion 4814, for example, by providing a hinge 4812a therebetween. A lollipop 4818 having a hard candy portion 4820 is connected to the upper container portion 4816.

In use, a person grabs the upper container portion 4816 and pulls upwardly to open the container 4812 to expose the lollipop 4818. A person licks the outer surface of the lollipop 4818, and then closes the upper container portion 4816 down onto the lower container portion 4814 causing the lollipop 4818 to make contact with the edible food product 4826 stored in the lower container portion 4814. The person then again reopens the container 4812 by pulling upwardly on the upper container portion 4816 again exposing the lollipop 4818 allowing the person to place the lollipop 4818 in his or her mouth.

Another embodiment of the candy sucker article 4910 according to the present invention is shown in FIGS. 88 and 89.

The candy sucker article 4910 includes a container 4912 having a lower container portion 4914 connected to an upper container portion or lid 4916. The container 4912 can be configured to simulate a gemstone ring. The upper container portion 4916 is removably connected to the lower container portion 4914, for example, by providing a snap fit connection therebetween. A lollipop 4918 having a hard candy portion 4920 is connected to the lower container portion 4916.

In use, a person turns the ring upside down on his or her finger. The person grabs the upper container portion 4916 and pulls downwardly to open the container 4912 to expose the lollipop 4918 connected to the lower container portion 4914. The person licks the outer surface of the lollipop 4918, and then inserts the lollipop 4918 into the upper container portion 4916 causing the lollipop 4918 to make contact with the edible food product 4926 stored in the upper container portion 4816. The person then again reopens the container 4912 to expose the lollipop 4918 allowing the person to place the lollipop 4918 in his or her mouth.

Another embodiment of the candy sucker article 5010 according to the present invention is shown in FIG. 90.

The candy sucker article 5010 includes a necklace 5011 in combination with a container 5012 having a lower container portion 5014 connected to an upper container portion or lid 5016. The container 5012 is configured to simulate a gemstone setting connected to the necklace 5011. The upper container portion 5016 is removably connected to the lower container portion 5014, for example, by providing a snap fit connection therebetween. A lollipop 5018 having a hard candy portion 5020 is connected to the lower container portion 5014.

In use, a person grabs the upper container portion 5016 and pulls downwardly to open the container 5012 to expose the lollipop 5018 connected to the lower container portion 5014. The person licks the outer surface of the lollipop 5018, and then inserts the lollipop 5018 into the upper container portion 5016 causing the lollipop 5018 to make contact with the edible food product 5026 stored in the upper container portion 5016. The person then again reopens the container 5012 to expose the lollipop 5018 allowing the person to place the lollipop 5018 in his or her mouth.

Another embodiment of the candy sucker article 5110 according to the present invention is shown in FIG. 91.

The candy sucker article 5110 includes a container 5112 having a lower container portion 5114 connected to an upper container portion or lid 5116. The upper container portion 5116 is removably connected to the lower container portion 5114, for example, by providing a snapfit connection, twist or threaded connection therebetween. The upper container portion 5116 is provided with a handle portion 5117. A lollipop 5118 having a hard candy portion 5120 connected to a stick portion 5122 extends downwardly from the upper lid portion 5116. The lollipop 5118 is configured to simulate a spoon.

In use, a person grabs the handle portion 5117 and pulls upwardly or twists same to remove the lollipop 5118 from the lower container portion 5114. A person licks the outer surface of the lollipop 5118, and inserts the lollipop 5118 into the lower container portion 5114. The person can shake the candy sucker article 5110 to apply edible food product 5126 stored within the lower container portion 5114 onto the outer surface of the lollipop 5118. The person then again removes the lollipop 5118 from the lower container portion 5114, and places the lollipop 5118 in his or her mouth.

Another embodiment of the candy sucker article 5210 according to the present invention is shown in FIG. 92.

The candy sucker article 5210 includes a container 5212 having a lower container portion 5214 connected to an upper container portion or lid 5216. The upper container portion 5216 is removably connected to the lower container portion 5214, for example, by providing a snapfit connection, twist or threaded connection therebetween. A lollipop 5218 having a hard candy portion 5220 connected to a stick portion 5222 extends upwardly from the lower container portion 5214.

The lower container portion 5214 is configured to twist or turn the lollipop 5218 both when disposed within the lower container portion 5214, and when removed from the lower container portion 5214. For example, the lower container portion 5214 is provided with a spring loaded trigger or button 5214a. When the trigger or button 5214a is pushed in, a manually operated mechanism located within the lower container portion 5214 rotates the lollipop 5218. This step can be repeated to rotate the lollipop faster and faster.

In use, a person turns the container 5212 upside down and grabs the lower container portion 5214 and pulls upwardly or twists same to remove the lollipop 5218 from the lower container portion 5214. A person licks the outer surface of the lollipop 5218, and inserts the lollipop 5218 into the upper container portion 5216. The person activates the trigger or button 5214a to manually cause the lollipop 5218 to rotate to apply edible food product 5226 stored within the upper container portion 5216 onto the outer surface of the lollipop 5218. The person then again removes the lollipop 5218, and places the lollipop 5218 in his or her mouth.

Another embodiment of the candy sucker article 5310 according to the present invention is shown in FIGS. 93 and 94.

The candy sucker article 5310 includes a container 5312 having a lower container portion 5314 connected to an upper container portion or lid 5316. The lid 5316 is removably connected to the lower container portion 5314, for example, by providing a snapfit connection, twist or threaded connection therebetween. A lollipop 5318 having a hard candy portion 5320 extends downwardly from the upper lid portion 5316. The candy sucker article 5310 is configured to simulate a pen having a pocket clip 5316a connected to the upper lid 5316. The lower container portion 5314 is provided with edible food product 5326.

In use, a person grabs the upper container portion 5316 and pulls upwardly or twists same to remove the lollipop 5318 from the lower container portion 5314. A person licks the outer surface of the lollipop 5318, and reinserts the lollipop 5318 into the lower container portion 5314. The person can shake the candy sucker article 5310 to apply edible food product 5326 stored within the lower container portion 5314 onto the outer surface of the lollipop 5318. The person then again removes the lollipop 5318 from the lower container portion 5314, and places the lollipop 5318 in his or her mouth.

Another embodiment of the candy sucker article 5410 according to the present invention is shown in FIGS. 95 and 96.

The candy sucker article 5410 includes a container 5412 having a main container portion 5414 connected to multiple (e.g. three (3)) separate removable container portions or lids 5416a-c. The lids 5416a-c are removably connected to the main container portion 5414, for example, by providing a snapfit connection, twist or threaded connection therebetween. Three (3) lollipops 5418a-c having hard candy portion 5420a-c are connected to the lids 5416. The lollipop 5418 can be configured to simulate a spacecraft or unidentified flying object (UFO). The main container portion 5414 is provided with edible food product 5426.

In use, a person grabs one of the removable container portions 5416a-c and pulls or twists same out of the main container portion 5414 to remove one of the lollipops 5418a-c from the main container portion 5414. A person licks the outer surface of the lollipop 5418a-c, and reinserts the lollipop 5418a-c into the main container portion 5414. The person can shake the candy sucker article 5410 to apply edible food product 5426 stored within the main container portion 5414 onto the outer surface of the lollipop 5418a-c. The person then again removes the lollipop 5418a-c from the main container portion 5414, and places the lollipop 5418 in his or her mouth.

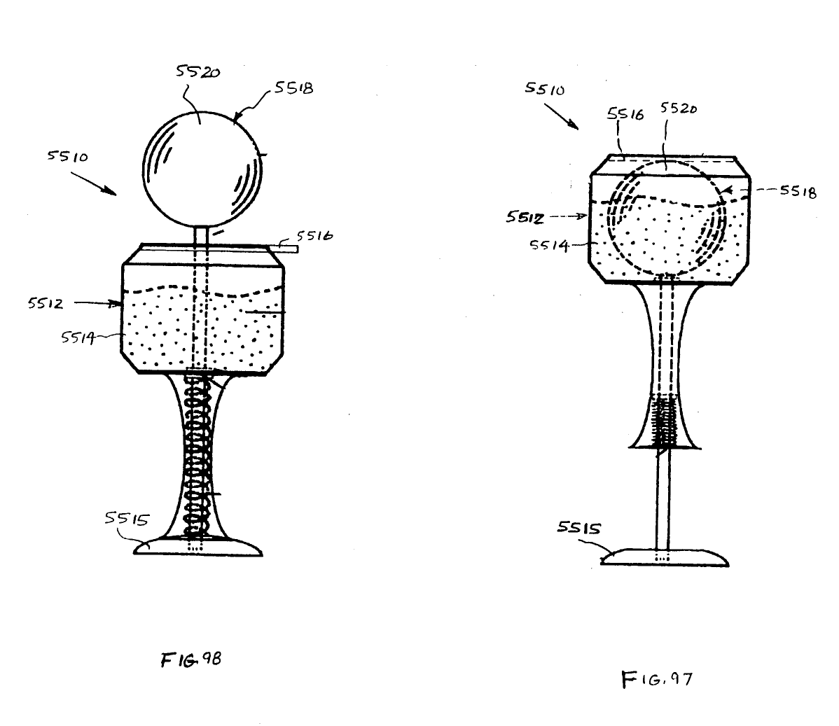

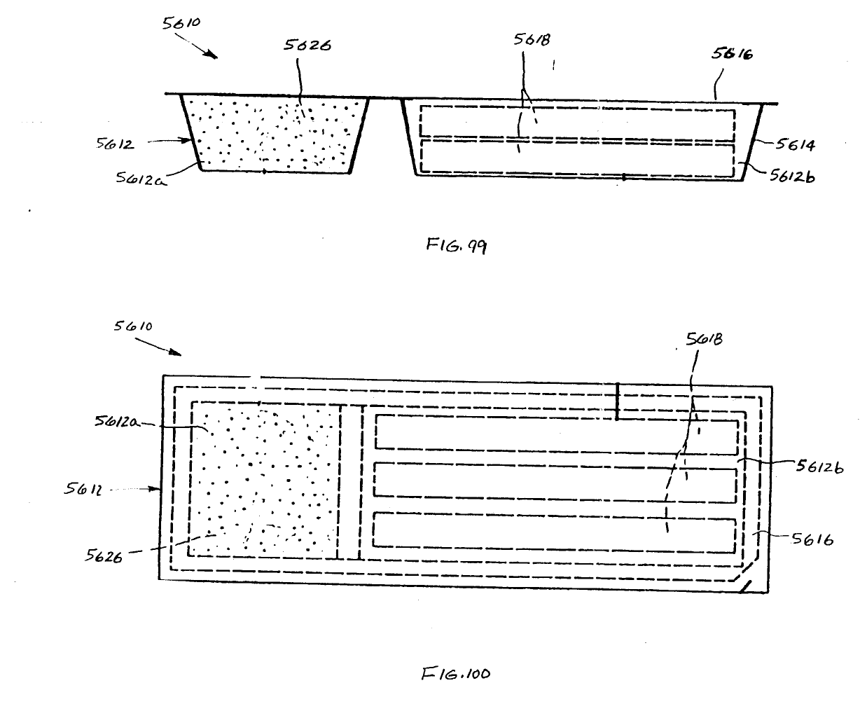

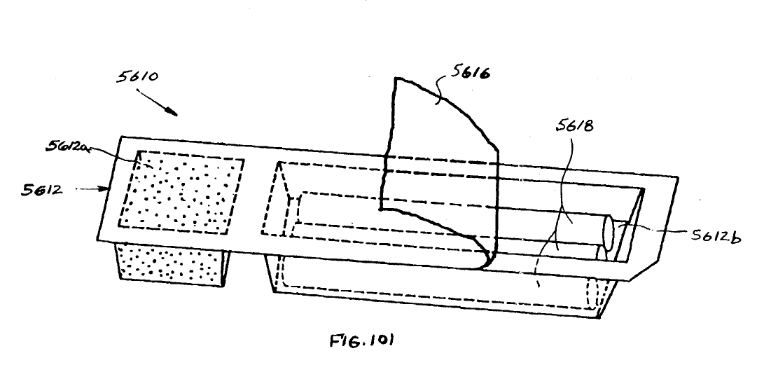

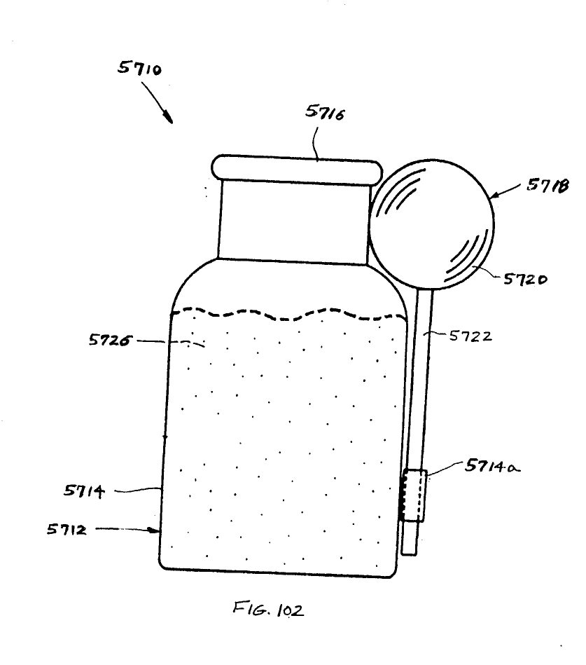

Another embodiment of the candy sucker article 5510 according to the present invention is shown in FIGS. 97 and 98.

The candy sucker article 5510 includes a container 5512 having a lower container portion 5514 and a removable lid or seal 5516. For example, the removable lid or seal 5516 can be a removable snap cap, twist on/off closure or a removable seal optionally provided with a tab. A lollipop 5518 having a hard candy sucker 5520 connected to a stick 5522 is connected to a base 5515. Specifically, the base 5515 includes a recess 5515a configured to receive a free end of the stick 5522 of the lollipop 5518.

A spring 5517 is disposed within the container 5512, and is configured to apply an upward spring force to the lollipop 5518. Specifically, the spring 5517 is configured to forcibly bias the lollipop 5518 upwardly relative to the lower container portion 5514.

In use, a person initially removes the lid or seal 5516. The person licks the lollipop 5518, and then pulls downwardly on the base 5515 while holding the lower container portion 5514 stationary. This causes the lollipop 5518 to be lowered into the lower container portion 5514 to apply edible food product 5526 to the lollipop 5518. The person then releases the base 5515 allowing the lollipop 5518 to raise back out of the lower container portion 5514 to again be licked by the user.

Another embodiment of the candy sucker article 5610 according to the present invention is shown in FIGS. 99-101.

The candy sucker article 5610 includes a container 5612 having a lower container portion 5614 and a removable lid or seal 5616. For example, the removable lid or seal 5616 can be a removable foil and/or film seal with a pull tab 5616a. The lower container portion 5614 is configured with two (2) separate compartments 5614a and 5614b. An edible food product 5626 is stored within compartment 5614a and a plurality of lollipops 5618 having hard candy suckers 5620 are disposed within the compartment 5614b of the lower container portion 5614.

In use, a person removes the lid or seal 5616 from the lower container portion 5614, and grabs one of the lollipops 5618. The person licks one end of the lollipop 5618, and then dips that end into the edible food product 5626 to apply same thereon. The person then licks the lollipop 5618 and edible food product 5626. This same end can then again be dipped into the edible food product 5626 repeatedly.

Another embodiment of the candy sucker article 5710 according to the present invention is shown in FIG. 102.

The candy sucker article 5710 includes a container 5712 having a lower container portion 5714 and a removable lid or seal 5716. For example, the removable lid or seal 5716 can be a snap cap, twist cap, or removable foil and/or film seal with a pull tab. The lower container portion 5714 is configured with a compartment for storing edible food product 5726 therein. A lollipop 5718 having a hard candy sucker 5720 connected to a stick portion 5722 is releasably connected to the lower container portion 5714. Specifically, the lower container portion 5714 is provided with a sleeve portion 5714a configured to receive and retain a lower end of the stick portion 5722.

In use, a person removes the lid or seal 5716 from the lower container portion 5714, and removes the lollipop 5718 from the sleeve portion 5714a of the lower container portion 5714. The person licks the hard candy sucker 5720 of the lollipop 5718, and then dips that end into the edible food product 5726 to apply same thereon. The person then licks the lollipop 5718 and edible food product 5726. The hard candy sucker 5720 can then again be dipped into the edible food product 5626 repeatedly.

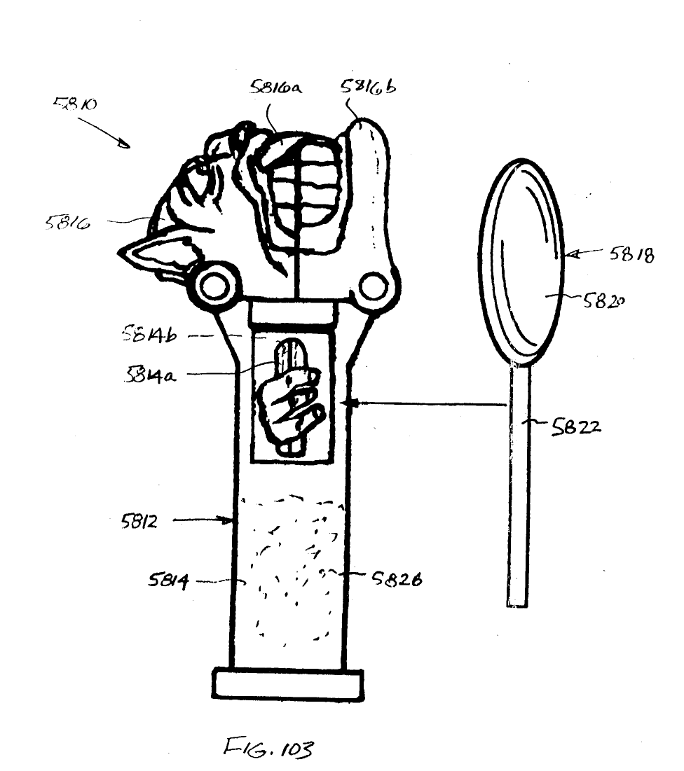

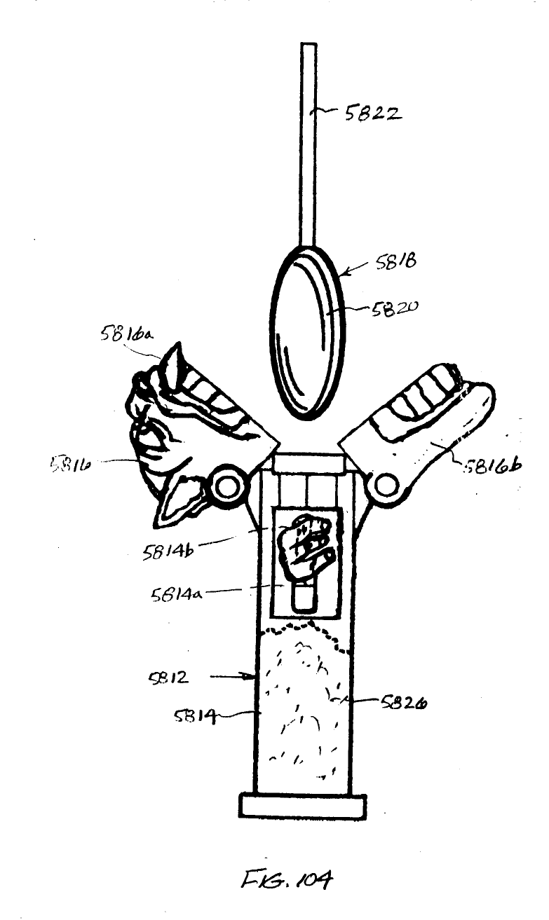

Another embodiment of the candy sucker article 5710 according to the present invention is shown in FIGS. 103 and 104.

The candy sucker article 5810 includes a container 5812 having a lower container portion 5814 and an upper container portion or lid 5816. The lid 5816 is configured to be selectively opened and closed by the user. For example, the lid 5816 includes lid portions 5816a and 5816b connected by hinge portions 5817a and 5817b, respectively, to the lower container portion 5814. The hinge portions 5817a and 5817b can be biased closed (e.g. by a spring). Alternatively, the hinge portions 5817a and 5817b can be freely moveable, however, a locking mechanism (e.g. detent or snap connection) can be provided to releasably hold the hinge portions 5817a and 5817b together.

The lower container portion 5814 is configured with a compartment for storing edible food product 5826 therein. A lollipop 5818 having a hard candy sucker 5820 connected to a stick portion 5822 is releasably connected to the lower container portion 5814. For example, the lower container portion 5814 is provided with an extension 5814a having an aperture 5814b configured to receive and retain a lower end of the stick portion 5822 of the lollipop 5818.

In use, a person separates the lollipop 5818 from the lower container portion 5814 and licks the lollipop 5818. The user then opens the lid 5816 by pulling the lid portions 5816a and 5816b apart, and then dipping the lollipop 5818, as shown, into the compartment of the lower container portion 5814 placing the lollipop 5818 in contact with the edible food product 5826. After applying the edible food product 5826 onto the lollipop 5818, the lollipop 5818 is removed from the lower container portion 5814 and then again licked by the user. The lollipop 5818 can then again be dipped into the edible food product 5626 repeatedly

What is claimed is:

1. A candy sucker device, comprising:
a container configured to store an edible food product; and
a candy sucker disposed within said container, said candy sucker configured to be manually rotated within said container and in contact with the edible food product when said container is closed, whereby the edible food product is applied to said candy sucker.

2. A device according to claim 1, wherein said sucker is a lollipop defined by a piece of hard candy disposed on an end of a stick.

3. A device according to claim 2, wherein said stick extends through a wall portion of said container and is manually rotatable relative to said container.

4. A device according to claim 3, wherein said container includes a removable closure, and said stick of said lollipop extends through a wall portion of said closure.

5. A device according to claim 4, wherein said closure is one selected from the group consisting of cap, lid, stopper and plug.

6. A device according to claim 1, including a manually rotary device connected to said sucker, said rotary device configured to manually rotate said sucker relative to said container.

7. A device according to claim 6, wherein said manual rotary device extends through a wall portion of said container.

8. A device according to claim 7, wherein said container includes a removable closure, and said manual rotary device extends through a wall portion of said closure.

9. A device according to claim 7, wherein said manual rotary device includes a finger grip portion located external to said container.

10. A device according to claim 6, wherein said sucker is molded onto said manual rotary device.

11. A device according to claim 6, wherein said sucker is a lollipop defined by a piece of hard candy located on an end of a stick, said stick being connected to said manual rotary device.

12. A device according to claim 10, wherein said manual rotary device is a spindle extending through a wall portion of said container.

13. A device according to claim 7, wherein said container includes a removable closure, and said spindle extends through a wall portion of said closure.

14. A device according to claim 1, including a manual drive device configured for rotating said sucker.

15. A device according to claim 14, wherein said manual drive device is configured to be manually wound up.

16. A device according to claim 15, wherein said drive device is configured to store winding energy.

17. A device according to claim 1, including at least one edible food product stored within said container, said edible food product being selected from the group consisting of powdered food product, powder candy product, powdered sugar product, particulate food powder, particulate candy product, particulate sugar product, flavored food product, cookie crumbs and candy sprinkles.

18. A candy sucker device, comprising:
a container configured to store an edible food product;
a candy sucker associated with said candy device; and
a manual rotary device connected to said container, said manual rotary device including a rotating portion connected to said candy sucker and configured to rotate relative to said container, whereby said candy sucker is manually rotated within said container and in contact with the edible food product to apply the edible food product to said candy sucker.

19. A device according to claim 18, herein said rotary device is configured to be manually operated.

20. A device according to claim 19, wherein said manual rotary device is finger operated.

21. A device according to claim 19, wherein said manual rotary device is configured to directly drive said candy sucker.

22. A device according to claim 19, wherein said manual rotary device is configured to indirectly drive said sucker.

23. A device according to claim 18, including a manual drive device configured to store drive energy.

24. A device according to claim 23, wherein said manual drive device is configured to be selectively operated once energized.

25. A candy sucker device, comprising:
a container configured to store an edible food product; and
a candy sucker associated with said candy device; and
a manually operated vibrating device associated with said candy device.

26. A device according to claim 25, wherein said candy device is configured to apply the edible food product to said candy sucker by action of said manually operated vibrating device.

27. A device according to claim 26, wherein said manually operated vibrating device is connected to said container for vibrating said container.

28. A device according to claim 26, wherein said manually operated vibrating device is connected to said candy sucker for vibrating said container.
